(19) United States
(12) Patent Application Publication
(10) Pub. No.: US 2024/0281716 A1
(43) Pub. Date: Aug. 22, 2024

(54) SYSTEMS AND METHODS FOR IMPLEMENTING TRANSACTIONAL PROMOTIONS

(71) Applicant: Synchrony Bank, Stamford, CT (US)

(72) Inventors: Theresa Kraus, Stamford, CT (US); Nathan Feighner, Stamford, CT (US); Craig Urbansky, Stamford, CT (US); Gretakae Northern, Stamford, CT (US); William Schroeder, Stamford, CT (US); Jay Neidermeyer, Stamford, CT (US); Stephen Roe, Stamford, CT (US); Kristine Hanson, Stamford, CT (US)

(21) Appl. No.: 18/651,726

(22) Filed: May 1, 2024

Related U.S. Application Data
(63) Continuation-in-part of application No. 16/848,340, filed on Apr. 14, 2020.
(60) Provisional application No. 62/834,103, filed on Apr. 15, 2019.

(51) Int. Cl. G06N 20/00

(52) U.S. Cl. CPC G06N 20/00

(57) ABSTRACT

Examples described herein include systems, methods, instructions, and other implementations of different objects. One embodiment includes receipt of an authorization request message for an instrument utilization associated with a record identifier. The authorization request message includes an external system category code and does not include object information. A determination is then made that the instrument utilization is eligible for an object based on the external system category code. The object is then automatically applied to the instrument utilization at the record identifier, and an authorization response message is then generated authorizing the instrument utilization.

### CROSS-REFERENCES TO RELATED APPLICATIONS

This application is a continuation-in-part of U.S. patent application Ser. No. 16/848,340, filed Apr. 14, 2020, and which claims the benefit of U.S. Provisional Application No. 62/834,103, filed Apr. 15, 2019, which are hereby incorporated by reference, in their entireties for all purposes.

### FIELD

The present disclosure relates generally to instrument utilizations. In one example, the systems and methods described herein may be used to implement objects in a variety of instrument utilization contexts.

### BACKGROUND

Certain objects are important for external systems to implement in order to encourage users to engage in various instrument utilizations at their establishments. These objects may come in a variety of forms. For example, an object may correspond to a reduction or an addition premium with the completion of an eligible instrument utilization. Objects may also be made in conjunction with instrument providers. For example, an object may be an incentive for use with a particular network instrument.

### SUMMARY

Disclosed embodiments may provide a framework to implement instrument utilization objects automatically without external system participation in the process. A user utilizing a network instrument associated with a particular network may receive an object for instrument utilizations over a certain threshold at certain locations and within allowable external system category codes for instrument utilizations. Embodiments provide a significant improvement over traditional methods where external systems were required to manually enter an object code along with the instrument utilization information for the authorization system to process the authorization and apply the promotion.

In some implementations, instrument utilization objects for out-of-network external systems which are applied automatically without participation of the out-of-network external systems can be performed alongside instrument utilization objects for in-network external systems, where the in-network external systems participate in the promotion process.

According to some embodiments, a computer-implemented method is provided. The method comprises receiving an authorization request message for an instrument utilization associated with a record identifier, wherein the authorization request message includes an external system category code, and wherein the authorization request message does not include promotion information; determining that the instrument utilization is eligible for an object based on the external system category code; automatically applying the promotion to the instrument utilization at the record identifier; and generating an authorization response message authorizing the instrument utilization.

According to some embodiments, a computer-program product is provided. The computer-program product is tangibly embodied in a non-transitory machine-readable storage medium, including instructions that, when executed by one or more processors, cause the one or more processors to perform the steps of the above method.

According to some embodiments, a system is provided. The system comprises one or more processors, and one or more non-transitory machine-readable storage media containing instructions that, when executed on the one or more processors, cause the one or more processors to perform operations including the steps of the above method.

This summary is not intended to identify key or essential features of the claimed subject matter, nor is it intended to be used in isolation to determine the scope of the claimed subject matter. The subject matter should be understood by reference to appropriate portions of the entire specification of this patent application, any or all drawings, and each claim.

The foregoing, together with other features and examples, will be described in more detail below in the following specification, claims, and accompanying drawings.

### BRIEF DESCRIPTION OF THE DRAWINGS

The present disclosure is described in conjunction with the appended figures:

FIG. 1 depicts aspects of a system that can be used with implementations of instrument utilization objects in accordance with examples described herein.

FIG. 2 depicts aspects of operation of an instrument utilization communication system in accordance with some examples.

FIG. 3 depicts aspects of operation of an instrument utilization communication system in accordance with some examples.

FIG. 4 depicts aspects of operation of an instrument utilization communication system in accordance with some examples.

FIG. 5 is a flow diagram illustrating an example method in accordance with some embodiments.

FIG. 6 depicts aspects of a system that can be used with implementations of instrument utilization objects in accordance with some examples described herein.

FIG. 7 depicts aspects of operation of an instrument utilization communication system in accordance with some examples.

FIG. 8 depicts aspects of operation of an instrument utilization communication system in accordance with some examples.

FIG. 9 depicts aspects of operation of an instrument utilization communication system in accordance with some examples.

FIG. 10 is a flow diagram illustrating an example method in accordance with some embodiments.

FIG. 11 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides examples of embodiment(s) only and is not intended to limit the scope, applicability or configuration of the disclosure. Rather, the ensuing description of the examples of embodiment(s) will provide those skilled in the art with an enabling description for implementing examples of embodiment. It is understood that various changes can be made in the function and arrangement of elements without departing from the spirit and scope as set forth in the appended claims.

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework to implement instrument utilization objects automatically without external system participation in the process. In previous systems, external system participation was part of such object distributions, with a user of the external system manually providing object codes as part of such an object distribution. In some examples, a user utilizing a network instrument may receive an object for instrument utilizations over a certain threshold at certain locations and within allowable external system category codes for these instrument utilizations. Embodiments provide a significant improvement over traditional methods where a user of an external system was required to manually enter an object code along with the instrument utilization information for an authorization system to process the authorization and apply the object.

Additionally, an authorization system in some examples can include both systems for implementing instrument utilization objects without external system participation as described above, as well as systems for implementing instrument utilizations with instrument utilization objects. In some examples, external systems in a network have sub-systems (e.g. computing devices implemented by the external systems) that are part of a network associated with a payment instrument. Such external systems can have associated devices (e.g. point-of-sale (POS) terminals or user terminals) configured to accept object codes and to generate notices of promotions at the point-of-sale. Such systems can thus provide special communications (e.g.

printed notice of object terms) directly to a user after a payment is authorized by an authorization system of an instrument utilization communication network. For external systems that are not part of such a network and not configured to provide such notices, an alternate promotion system can be implemented that operates without involvement of the external system. Such examples further improve the operation of an instrument utilization communication network by enabling functionality for a broader range of external systems than those limited to specially configured in network external systems. Such improvements can include a communication path for providing notice of object terms that occurs outside of the instrument utilization communication network before the authorization occurs, so that the user is informed of object terms prior to any instrument utilization. In some embodiments, such paths can be implemented via communication with a user device, or by communications that accompany a user network instrument as it is delivered to a user. By enabling both in network and out of network promotions, examples described herein improve the operations of the instrument utilization communication network and devices operating within the instrument utilization communication network.

In some embodiments, the system coding for promotions may be a new custom setting to follow the user record with promotions through an authorization system (e.g. mainframe systems or networked computing devices operating as part of an instrument utilization communication network that includes promotion systems integrated with instrument utilization authorization). In some examples, promotions within an instrument utilization communication system may be set up at the user record system hierarchy level. Based on the variable provided (e.g. system, instrument utilization amount, and external system category codes) to the authorization system, the authorization system (e.g. mainframe or other computing devices implementing operations for authorization) may utilize object distribution tables to apply an object to the user record for that individual sale. For example, the promotion can provide six months with deferred interest. Other promotions can provide initial interest rates, or other such benefits such as financing offers, rewards, or the like.

Additional details of various example implementations for implementing instrument utilization objects within an instrument utilization communication network are described below.

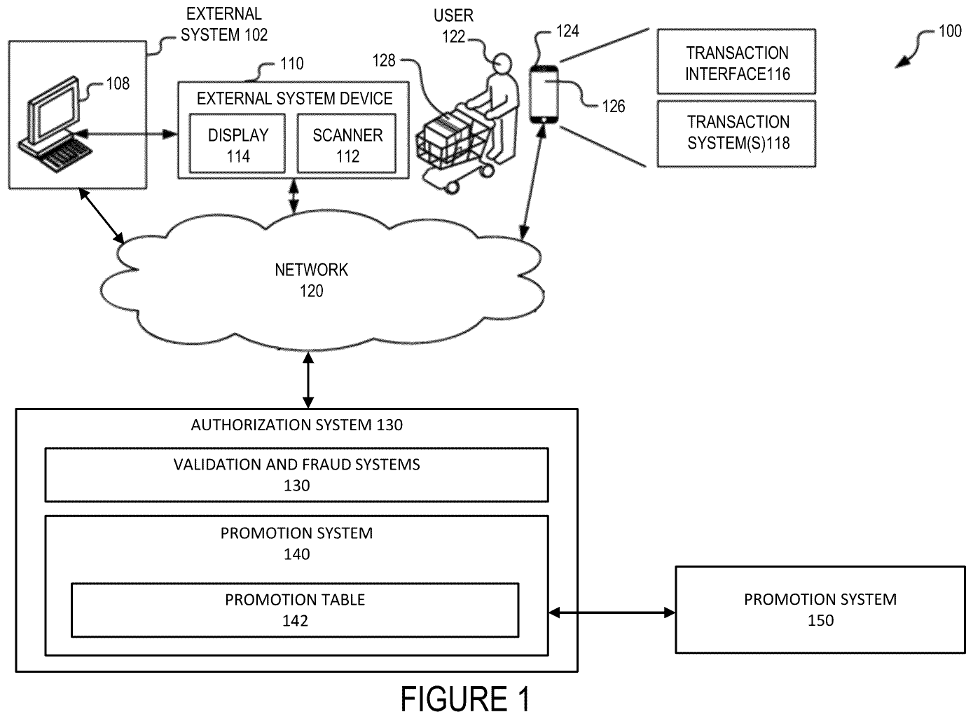

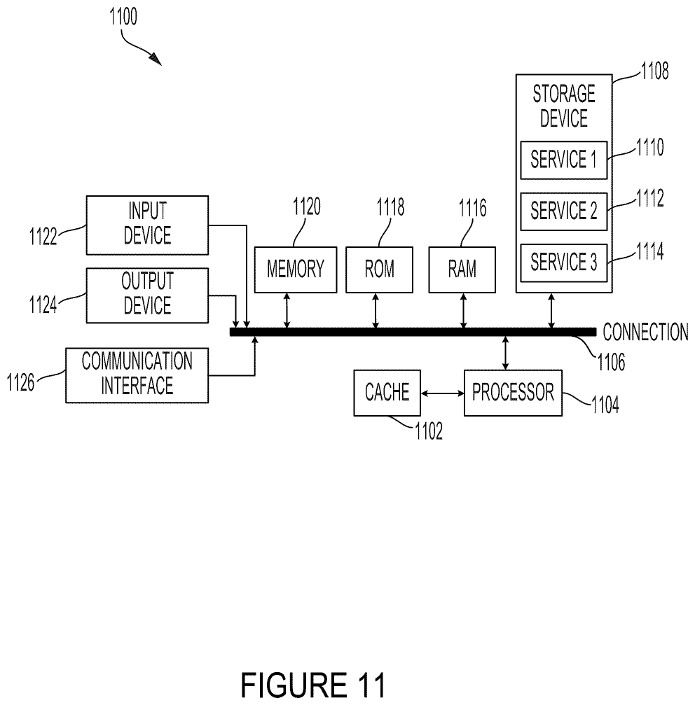

FIG. 1 is a block diagram of an instrument utilization communication network 100 in which network data management and instrument utilization object communications are performed in accordance with some examples. The example instrument utilization communication network 100 includes an external system 102 implementing a an external sub-system 108, which can be one or more networked computing devices that can be networked both with an external system device 110 (e.g. a checkout register, point-of-sale (POS) devices, or any other such device) and a network 120. The external system device(s) 110 can include a scanner 112 (e.g. any input devices for accepting information associated with an instrument utilization) and a display device 114. Other implementations can include a network instrument scanner or other payment input, a keypad, or other such elements. Additional examples of an originating external system device 110 can be a tablet device, a smartphone, a laptop computer, or any other such device that can be accessed by a user, either directly, or through a user of the external system. The external sub-system 108 may be directly connected or connected by one or more networks 120 to the external system device 110. The external sub-system 108 and the external system device 110 may each be implemented by one or more computing devices, which may each be implemented as a computing device with architecture 1100 described below and illustrated in FIG. 11.

Referring to FIG. 1, the external system device 110 is configured to perform operations associated with an instrument utilization for a user 122 and one or more items 128 associated with one or more external system category codes. In some examples, a user maintains a user device 124 (e.g., a cellular telephone, a chip card, a network instrument, etc.) associated with a user record. Some examples of a user device 124 can include a display device 126 (e.g., a conventional touch screen) which can include an instrument utilization interface 116 and/or device instrument utilization systems 118. Other implementations can operate with a user device 124 that does not include a display device (e.g. a network instrument).

A user 122 may engage in an instrument utilization for one or more items 128 through the external system device 110 using a user device 124, which can include a network instrument with a magnetic stripe, a network instrument with an embedded microchip, a contactless network instrument, a phone application or mobile instrument utilization device (e.g. integrated with a smartphone), or other such user devices 124. When the user interacts with the external system device 110 to initiate an instrument utilization at an external system location, the external system device 110 is configured to implement an instrument utilization channel based on the particular user device 124 used for the payment. When the user 122 uses their user device 124 through the external system device 110, the external system device 110 automatically, and in real-time, generates and communicates an authorization request message for the present instrument utilization. For certain authorization request messages operating outside of an object program configured for an external system, the authorization request message can include one or more external system category codes or other such category codes with no object details. The authorization request message generated by the external system device 110 during the present instrument utilization can be routed, through a communications network 120 and in real-time, to an authorization system 130. In response to receiving the authorization request message from the external system device 110, the authorization system 130 automatically and in real-time processes the authorization request message to generate an authorization response, and to apply object details that are applicable to the user based on the one or more external system category codes associated with the present instrument utilization. These object details may be automatically applied to the present instrument utilization independent of any external system object. In such examples, the authorization system can identify an object, and respond with an authorization response message that includes an indication that the instrument utilization has been approved. However, this authorization response message generated by the authorization system 130 may not include any of the identified object details associated with the present instrument utilization. Any communications regarding the object details, since they are independent of the external system, can be communicated with a distinct settlement statement provided to the user 122 or user device 124 (e.g. for smartphone or computing device user devices) without any external system intervention.

An authorization entity can operate one or more authorization computing devices as part of an authorization system 130 configured as part of an instrument utilization communication network 100. The authorization system 130 can include various sub-systems or component functions implemented on processors of the authorization system to enable authorization of instrument utilizations between users 122 and external systems 102. The authorization system 130 can include validation and fraud systems 130, as well as an object system 140. Validation and fraud systems can include computing systems for validating network record identifiers from user device 124 to confirm that corresponding network record can be used to fulfill the instrument utilization amount associated with an instrument utilization being authorized.

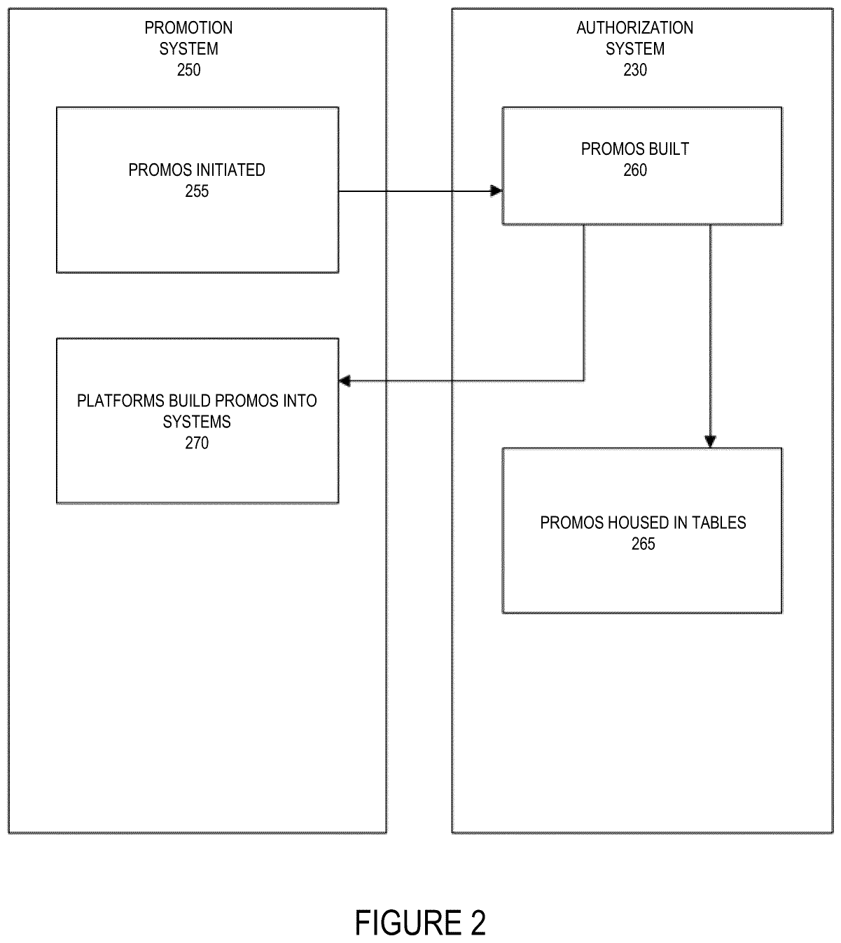

Additional fraud analysis operations can analyze and process information associated with any aspect of an instrument utilization to approve or deny an authorization request. When an authorization request results in an approval, object system 140 can, in accordance with some examples, confirm that an external system and one or more external system category codes are associated with an object using an object table stored in authorization system 130. This information can be provided by an independent object system 150, which is described in more detail in various examples below. In some examples, the object system 150 is associated with a network instrument provider or other aspects of an instrument utilization communication system, and can be applied to the instrument utilization at the network record identifier by the authorization system 130, with such information stored in a database, either at authorization system 130 or in another system associated with the network instrument provider. In examples where an object table 142 is used to identify and apply an object independent of an external system 102, a communication confirming the object can be generated from data stored with object system 150 or another issuer system, and communicated directly from such a system (e.g. object system 150) to user 122 outside of the authorization system 130. Examples of various communications between authorization systems, external systems, user devices, and additional systems such as object system 150, are described below in FIGS. 2-7.

In an embodiment, the object system 140 implements a machine learning algorithm or artificial intelligence that is dynamically trained to identify and apply an object independent of external systems 102. The machine learning algorithm or artificial intelligence may be dynamically trained using a dataset of sample instrument utilizations (e.g., historical instrument utilizations processed by the authorization system 130 or other systems, hypothetical instrument utilizations, etc.), sample record data associated with the sample instrument utilizations, and sample objects resulting from the sample instrument utilizations and corresponding record data. The machine learning algorithm or artificial intelligence may be further subject to one or more criteria that may be used to evaluate the output of the machine learning algorithm or artificial intelligence according to the dataset (e.g., output objects selected from a set of available objects based on the sample inputs in the dataset). For instance, the set of criteria may include a threshold for the accuracy of the desired machine learning algorithm or artificial intelligence for selecting one or more objects for an authorized instrument utilization and for which the corresponding record is eligible.

To dynamically train the machine learning algorithm or artificial intelligence to identify and select an object that may be applied to an approved instrument utilization, the object system 140 may generate an initial iteration of the machine learning algorithm or artificial intelligence. For instance, the object system 140 may initialize a set of coefficients {α1, α2, α3, . . . αn} randomly according to a Gaussian distribution with low variance centered around zero. Using this initial iteration of the machine learning algorithm or artificial intelligence, the object system 140 may process the training dataset to generate an output. This output may specify, for each sample instrument utilization included in the dataset, an indication of whether the instrument utilization is eligible for an object and, if so, the particular object selected to be applied to the instrument utilization. The object system 140 may compare the output generated using the initial iteration of the machine learning algorithm or artificial intelligence to the sample objects defined in the dataset for each of the data points (e.g., sample instrument utilizations) to identify any inaccuracies or other errors.

If the output of the machine learning algorithm or artificial intelligence does not satisfy the one or more criteria, the object system 140 may iteratively update one or more coefficients of the set of coefficients to generate an updated machine learning algorithm or artificial intelligence. This updated machine learning algorithm or artificial intelligence may be used to process the aforementioned dataset, as well as any additional data points or datasets provided by the authorization system 130 or other entity (e.g., a network instrument provider, etc.), to generate a new output. In some instances, the object system 140 may use an optimization algorithm to iteratively update one or more coefficients of the set of coefficients. For instance, the object system 140 may use gradient descent to update the logistic coefficients of the machine learning algorithm or artificial intelligence to enable generation of new cutoff values that may be used to classify the data points of the previously evaluated dataset and of any new data points obtained by the object system 140. The object system 140 may use this updated machine learning algorithm or artificial intelligence to process the available data points and generate a new output. The object system 140 may evaluate this new output to determine whether the output satisfies the one or more criteria. This process of updating the set of coefficients associated with the machine learning algorithm or artificial intelligence according to the one or more criteria may be performed iteratively until an updated machine learning algorithm or artificial intelligence is produced that satisfies the one or more criteria.

In an embodiment, if the output generated by the machine learning algorithm or artificial intelligence satisfies the one or more criteria, the object system 140 implements the machine learning algorithm or artificial intelligence to dynamically, and in real-time, process any instrument utilizations from different external systems 102 to determine whether these instrument utilizations are eligible for objects that may be applied to corresponding user records and, if so, which objects are to be applied to these eligible instrument utilizations. In an embodiment, the object system 140 uses new instrument utilization data corresponding to newly processed instrument utilizations and any applicable objects applied to these instrument utilizations (if any) to further retrain or otherwise update the machine learning algorithm or artificial intelligence. For instance, as the machine learning algorithm or artificial intelligence produces, in real-time or near real-time, outputs corresponding to different objects that may be applied to different instrument utilizations being processed in real-time or near real-time by the authorization system 130, the object system 140 or other evaluator of the machine learning algorithm or artificial intelligence (e.g., a network instrument provider, a third-party auditing service, etc.) may evaluate the output to determine whether the corresponding user records are eligible for the identified objects. This evaluation may result in additional annotated data points that may be used to retrain or otherwise update the machine learning algorithm or artificial intelligence in real-time or near real-time. For instance, if the machine learning algorithm or artificial intelligence produces an object for which a corresponding user record and/or instrument utilization is not eligible for, the corresponding instrument utilization may be annotated to indicate that the machine learning algorithm or artificial intelligence has erroneously selected the object for the particular instrument utilization. Additionally, in some instances, the corresponding instrument utilization may be annotated with the correct determination (e.g., a determination that the instrument utilization is not eligible for an object, the object that should have been selected for the instrument utilization, etc.). These annotated data points may be added to the training dataset, which may be used to dynamically retrain or otherwise update the machine learning algorithm or artificial intelligence using the process described above.

In addition to the systems described above, an authorization system 130 can in various implementations, include additional systems for security, fraud detection, and other functionalities. Some implementations can include a token service that can act in a number of ways to facilitate secure communications between user 122 and various other services and devices, including external sub-system 108 and other systems. Tokenization is a process of substituting sensitive data elements with non-sensitive equivalents (e.g. tokens). The token is a reference identifier that can be mapped to the sensitive data via token service. Such a token service can use large random number in combination with other systems, such as timing systems, to limit and secure the use of sensitive data being communicated over networks such as instrument utilization communications network 120.

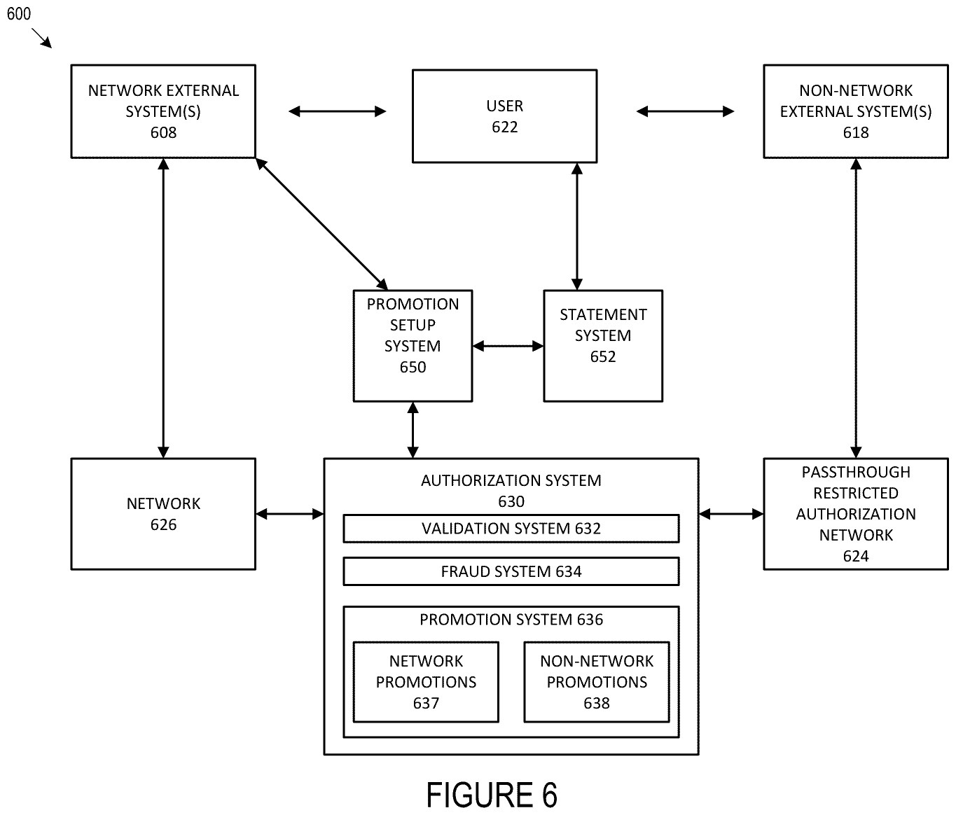

As described above, in some examples, authorization system 130 can be integrated with other systems, such as a network instrument service and communication channels with a user 122 outside the authorization channels used to communicate authorization request messages and responses between external system devices (e.g. external system device 110) and devices of an authorization system (e.g. authorization system 130). In such a system various additional functionalities can be integrated for security and instrument utilization system improvements, such as the use of token services as described above. Additionally, while FIG. 1 illustrates communications between various systems and devices, including external system device 110, external sub-system 108, user device 124, authorization system 130, object system 150, and network 120, in additional examples, other aspects of payment communication network 100 can further be altered or include additional or intervening elements, such as multiple users, users with shared records and devices, additional external systems, subsystems that can operate independently, additional communication channels, or other such structures. FIG. 6 illustrates aspects of some such details for another implementation of a payment communication system, and additional or alternative implementations are also possible in accordance with examples described herein.

FIG. 2 depicts aspects of operations of an instrument utilization communication system in accordance with some examples. In particular, FIG. 2 illustrates operations to create instrument utilization object data within an instrument utilization communication system that can later be used to associate an object with a particular instrument utilization (e.g., by comparing instrument utilization values from an authorization request message with object data in a table stored in an authorization system such as authorization system 230 and authorization system 130, by processing instrument utilization values through a machine learning algorithm or artificial intelligence to identify and select an object for the instrument utilization, etc.) without involvement of the external system, external sub-systems, or external system devices in the object other than non-object aspects of the authorization for the instrument utilization. Thus, object information is associated with an instrument utilization by automatically matching instrument utilization data with object limitations so that an object is applied to the instrument utilization data that matches the limitations for the object. This allows objects to be applied to an instrument utilization without involvement of the external systems, and without object information being included in an authorization request message.

As noted above, the authorization system may dynamically train and implement a machine learning algorithm or artificial intelligence to automatically associate an eligible object to an instrument utilization based on the instrument utilization data values associated with the instrument utilization and the available objects (including any object limitations). As described in greater detail herein, the machine learning algorithm or artificial intelligence may dynamically process, in real-time or near real-time and in response to an authorization request message, any instrument utilization values associated with the instrument utilization for which authorization is being sought, as well as any available user record information and objects, to determine whether the present instrument utilization is eligible for an object and, if so, the particular object that may be applied to the instrument utilization. This output may be provided to the authorization system 230 for further processing, as described in greater detail herein.

The example of FIG. 2 includes two entities involved in building out objects: an object system 250 (e.g. an object system similar to object systems 150 or 650, or applications for an object operating within a system); and authorization system 230 (e.g. a system similar to authorization systems 130, 630, or other such systems or mainframes). In the example of FIG. 2, the various systems perform operations to generate object data and to place the object data for use during authorization operations within a payment communication system. As illustrated by FIG. 2, at step 255, objects are initiated in object system 250 (e.g. by a system dedicated to managing and initiating objects). The objects of FIG. 2 are structured for application to instrument utilizations without the involvement of external systems, such that the object follows a user. Such objects can include limits and triggers input to system 250 by different groups associated with issuing network instruments to a user and organizing the devices and data for such network instruments (e.g. using user devices such as a network instrument or instrument utilization application on a smartphone). Such limits as part of an initiated object can include identifying external system category codes to be associated with an object, instrument utilization amounts, or other such limits for an object. Various examples of objects can be triggered based on external system category codes, total value of an instrument utilization, time of an instrument utilization, or any other such information. In some examples, the data used to assess whether an instrument utilization is eligible for an object is configured to be entirely assessed from instrument utilization values contained in an authorization request message. In other examples, additional data, such as instrument utilization histories associated with a user or user record, user location, user preferences provided to a system, user payment history information, or any other such information that can be stored in a database connected to authorization system 230 can be used to determine when an object is to be offered for a particular instrument utilization. In some instances, the instrument utilization values, any object limitations, and this additional data may be used as input to the aforementioned machine learning algorithm or artificial intelligence to dynamically determine whether the instrument utilization is eligible for an object and, if so, select an object that may be applied to the instrument utilization and the user record. In some examples, if certain instrument utilization parameter data is used as part of the object data, corresponding network instrument systems can add such data during step 255. After the initial object data is organized at object system 250, the object data is provided to authorization system 230. Authorization system 230 processes the object data in step 260 to build object tables. In step 265, the object tables are stored in memory of system 230 for use in later instrument utilizations as described below.

In an embodiment, rather than processing the received object data to build a set of object tables for use in later instrument utilizations, the authorization system 230 may use the provided object data to build a dataset that may be used to dynamically train the machine learning algorithm or artificial intelligence that is implemented to make object eligibility determinations and object selections for any received instrument utilization data. For instance, the authorization system 230 may use the provided object data to generate sample instrument utilizations for which the corresponding objects may be applicable. These annotated sample instrument utilizations and corresponding objects may be used to generate different data points that may comprise the training dataset. Accordingly, the authorization system 230, for the machine learning algorithm or artificial intelligence, may initialize a set of coefficients {α1, α2, α3, . . . , αn} randomly according to a Gaussian distribution with low variance centered around zero.

Using this initial iteration of the machine learning algorithm or artificial intelligence, the authorization system 230 may process the newly generated training dataset to generate an output. This output may specify, for each sample instrument utilization included in the dataset, an indication of whether the instrument utilization is eligible for an object and, if so, the particular object selected to be applied to the instrument utilization. The authorization system 230 may compare the output generated using the initial iteration of the machine learning algorithm or artificial intelligence to the sample objects defined in the dataset for each of the data points (e.g., sample instrument utilizations) to identify any inaccuracies or other errors and to determine whether the machine learning algorithm or artificial intelligence satisfies one or more criteria for deployment of the machine learning algorithm or artificial intelligence. Based on this evaluation, the authorization system 230 may iteratively update the machine learning algorithm or artificial intelligence until the one or more criteria are satisfied.

In step 270, the built object structures are then integrated into platforms operated in conjunction with object system 250. This integration can include issuer functionality, such as providing instrument utilization histories, general network instrument and instrument utilization terms, and periodic instrument utilization information or instrument utilization request data to a user. As part of building such an object into a platform using object system 250, communications are generated, such as disclosure communications to be sent to a user with a user device to be used in instrument utilizations. For example, a network instrument that is associated with the object initiated in step 255 to be provided to a user without external system involvement can have the terms of the object integrated with distribution of the network instrument to a user. This platform build notification provides the user notification of the terms of the object, so that the user will have been notified of the terms of the object prior to any instrument utilization automatically having the object applied without involvement of the external system or notification concurrent with the instrument utilization. In another example, if the user device is a smartphone instrument utilization system, the platform build can integrate notice of the terms into a user interface of the smartphone instrument utilization system to be distributed to a user's smartphone prior to the user engaging in any instrument utilizations. At the end of the steps illustrated by FIG. 2, the platform communications, including notification of the object terms, have been provided to users with records associated with the object, and the object data to be used by an authorization system in determining whether an object is to be applied to a particular instrument utilization are stored in the authorization system 230 including object data stored in tables as described in step 265 or used to train the aforementioned machine learning algorithm or artificial intelligence. This object data stored in the authorization system 230 allows for application of an object to an instrument utilization when an authorization request message does not include object information.

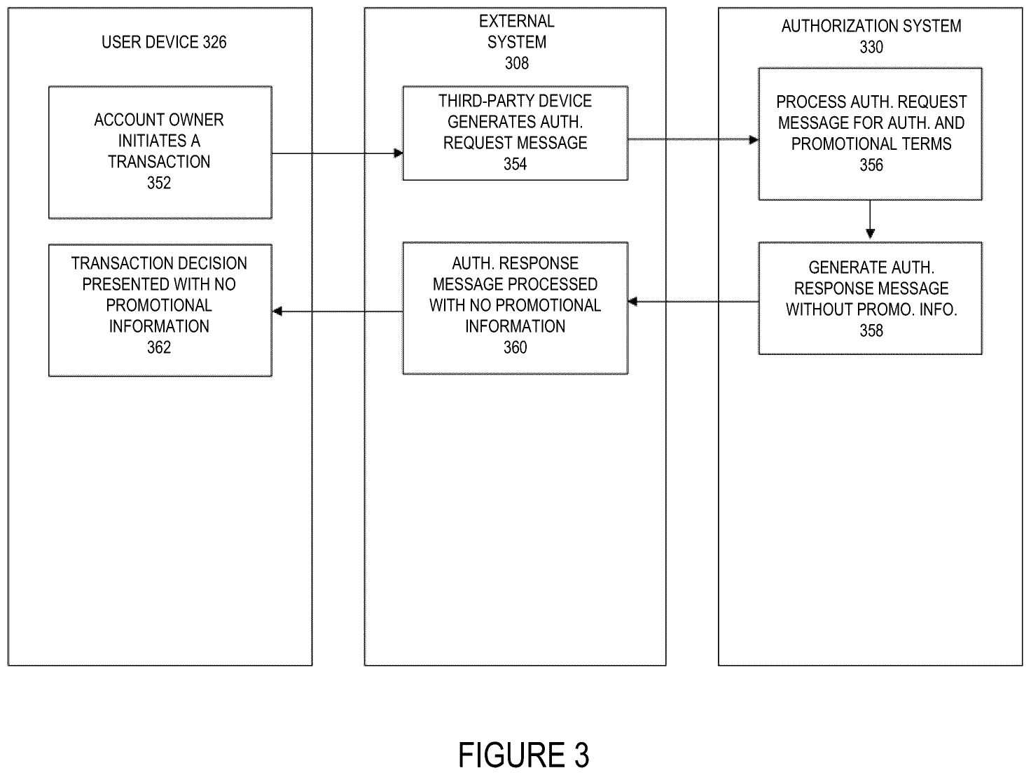

The object can then be implemented as part of an instrument utilization without involving external system devices or other external systems in any communication or selection of the object as illustrated in the example of FIG. 3. FIG. 3 depicts a system diagram for an instrument utilization using an object that follows a user device 326 and does not involve an external system 308 in the object. This authorization system 330 can, for example, use the object data and structures put in place as described in FIG. 2 (e.g., object tables, machine learning algorithm or artificial intelligence, etc.). The instrument utilization depicted in FIG. 3 involves three entities: a user via a user device 326, an external system 308, and an authorization system 330 (e.g. using an authorization computing device or mainframe within a system such as authorization system 130 or 630). Additional entities may be involved in the instrument utilization according to some embodiments (e.g. additional acquirer or issuer devices, third-party systems, etc.)

At step 352, the user may initiate an instrument utilization with an external system 308 using a user device 326 (e.g. a network instrument, an instrument utilization application on a user device, etc.) As described above, the external system in some implementations is not configured to manage objects. This lack of functionality can be because of external system device compatibility, external systems not being part of a particular program, or other such configurations. In some embodiments, the instrument utilization may be made at a location outside of a particular network instrument program. While a user device 326 can be associated with a network having particular objects selectable by an in-network external system, the user device 326 can still be used with an external system 308 that is not part of such a network. When the user device 326 is used to provide data to the external system 308 (e.g., by swiping a network instrument, providing data from the network instrument, or entry of an identifier exposed on a user device into an external system device, etc.) there may thus be no object choices due to the limitations of the external system 308. The external system 308 may process the instrument utilization as it would any other instrument utilization with no object data, so that the object is not to be applied by external system 308. In addition, there may be no object penalty to external systems outside of the interchange for that instrument utilization. Instead, the external system 308 simply accepts data to automatically generate an authorization request message as part of step 354 and the authorization request message for the instrument utilization is sent to authorization system 330. The authorization request message can include one or more external system category codes that may be associated with an object maintained in authorization system 330 or otherwise used to identify an applicable object. However, the object is otherwise unknown to the external system 308. In some implementations, the authorization request message can include additional instrument utilization values that can be used by authorization system 330, including a network indicator (e.g. an external system identifier), an instrument utilization amount, a record identifier for the user from user device 326, or any other such information.

The authorization request message can be routed to the authorization system 330 in a variety of ways. In some implementations, the authorization request message is sent via a restricted authorization network that is part of an instrument utilization communication network (e.g. instrument utilization communication network 100 or instrument utilization communication network 600, as described in greater detail herein in association with FIG. 6). As described above, the object implemented in authorization system 330 can be configured and applied without participation of an external system (e.g., external system 308), for example when a program includes in-network external systems, and the current external system 308 is not in the network. In such systems, such as the instrument utilization communication network 600 described in greater detail herein in association with FIG. 6, a standard network can be used for in-network external systems (e.g. network 626), and a restricted authorization network (e.g. passthrough restricted authorization network 624) can be used for out-of-network external systems. A single authorization system can accept authorization request messages from both types of external systems, but via different network paths. Additional details of such networks and systems are described below with respect to FIGS. 6-9.

At step 356, the authorization request message is received at authorization system 330 and processed in real-time or near real-time for authorization and for identification of any applicable object terms. This processing can include parsing data of the authorization request message for particular instrument utilization values. The processing of the authorization request message for instrument utilization authorization can include validation of record values, expiration dates, network instrument verification values, and other such data indicated in the authorization request message. This processing can also involve evaluating the present instrument utilization against any applicable fraud rules. Application of these fraud rules can involve a comparison of historical instrument utilizations (e.g. instrument utilization patterns or instrument utilization value compared with the current instrument utilization) or general instrument utilization patterns (e.g. an instrument utilization data compared against general risk associated with similar instrument utilizations), or locations against data from the authorization request message (e.g. a location of the external system 308 or user device 326). In various implementations, other such fraud evaluations can be used, though in some examples, a response time available for processing and generating an authorization response message is limited by standard timings.

If the instrument utilization is authorized, the identified instrument utilization values can be compared in real-time or near real-time with authorization and object term variables stored in authorization system 330, including object variables stored in an object table of authorization system 330. In some examples, the processing of step 356 can involve multiple tables in system 330. In one example, a user record table includes codes to assist system 330 in associating an appropriate object with a user based on instrument utilization values from an authorization request message. Based on the instrument utilization values and variables for the object, an object instrument utilization table within system 330 is used to apply the details of objects to a user record. The application of the object to the instrument utilization at the record identifier for the user can include processing at system 330 as well as communications to an additional system (e.g. an issuer system) so that communications with the user, including notices of payment due dates and current balances, can accurately represent the values associated with the instrument utilization based on the object as applied by authorization system 330 using the object distribution tables. In some implementations, all information for identifying the object terms and automatically applying the object terms are contained within the authorization request message and a table of object data within authorization system 330. In other implementations post-processing using data from multiple instrument utilizations can be used to bundle data from multiple instrument utilizations and apply object terms to some or all of the bundled instrument utilizations. For example, a bundled threshold can be used to apply object terms to instrument utilizations that occur after a threshold total value of all instrument utilizations exceeds a threshold amount. In other examples, the object terms can be applied to all instrument utilizations that occur in the time period once the bundled threshold amount is exceeded for all instrument utilizations in the time period. In other examples, other such post-processing can be used to apply object terms to instrument utilizations associated with system 330, with notice of the terms provided prior to the instrument utilizations occurring (e.g. as described below in connection with FIG. 6 and using a statement system 652 and object setup system 650).

In some examples, the post-processing using data from multiple instrument utilizations is performed for instrument utilizations associated with a restricted authorization network (e.g., instrument utilizations associated with out-of-network merchant systems) and that do not include any object terms. For this set of instrument utilizations, the system 330 may apply a bundled threshold for the instrument utilizations in the set to determine whether to apply, from the object distribution tables, object terms to these instrument utilizations. If the multiple instrument utilizations associated with the restricted authorization network exceed this bundled threshold, the system 330 may apply the object terms from the applicable object distribution tables without any merchant system interaction. In some instances, the post-processing using data from multiple instrument utilizations may be performed for any combination of instrument utilizations associated with a restricted authorization network (e.g., instrument utilizations associated with out-of-network merchant systems) and/or unrestricted authorization network (e.g., instrument utilizations associated with in-network merchant systems). This may allow for identification and application of object terms to different bundles of instrument utilizations regardless of the composition of these bundles (e.g., in-network, out-of-network, etc.) and provides greater flexibility for presentation of these object terms to users.

In an embodiment, step 356 is performed using a machine learning algorithm or artificial intelligence that is dynamically trained to process instrument utilization values provided in the authorization request message to identify one or more objects that may be applied to the instrument utilization within the user record. The authorization system 330, through this machine learning algorithm or artificial intelligence, may dynamically process, in real-time or near real-time and in response to an authorization request message, the provided instrument utilization values associated with the instrument utilization for which authorization is being sought, as well as any available user record information and objects, to determine whether the present instrument utilization is eligible for an object and, if so, the particular object that may be applied to the instrument utilization.

At step 358, an authorization response message is generated. The response is generated independent of any object, as the object is independent of the external system 308. If the instrument utilization is approved (e.g. authorized) the authorization response message is generated without object information because of the configuration of external system 308 as described above. If the instrument utilization is not approved, the object is irrelevant as there is no instrument utilization to apply the object to. The authorization response message is sent to the external system 308, and in step 360, the external system 308 receives and processes the authorization response message with no object information. As described above, since the object is applied directly to the user record and is not tied to the external system 308, the object data is not used at the external system 308. Similarly, in step 362, an instrument utilization decision based on the authorization response message is then presented to the user with no object information. As described above, the terms of the object, including when the object will be applied, are communicated to the user through a platform build prior to the instrument utilization (e.g. step 270 of FIG. 2). The object is thus automatically applied by authorization system 230 and any related system without concurrent notification to the user. While other instrument utilizations with in-network external systems can include such concurrent notification with involvement of the in-network external systems, the object distribution of FIG. 3 does not include such communications. As described above, improvement of the operation of an instrument utilization communication network is thus enabled for certain instrument utilizations that would not be possible in prior systems. Additionally, the operations of individual devices are improved with enablement of new instrument utilizations, and application of objects to instrument utilizations without the using of processing resources or communication resources at the external system and user level once the instrument utilization is authorized.

It should be noted that the system 330 can continuously and simultaneously process different authorization request messages from different merchant systems and for different instrument utilizations associated with any number of users and user devices 326. For instance, as the system 330 receives different authorization request messages from different out-of-network merchant systems for distinct instrument utilizations associated with different user devices, the system 330 may process these different authorization request messages as they are received to obtain any corresponding instrument utilization values and to evaluate the corresponding instrument utilization according to any applicable fraud rules. Further, the system 330 may process these corresponding instrument utilization values (in real-time or near real-time and as the authorization request messages are received) against any applicable authorization and object term variables maintained by the system 330, including any object variables stored in one or more object tables maintained by the system 330. Based on the identified instrument utilization values and object variables, the system 330 may use one or more object instrument utilization tables to apply the details of the applicable objects to the corresponding user records. Alternatively, the system 330 may process these corresponding instrument utilization values through the aforementioned machine learning algorithm or artificial intelligence to dynamically identify and select an object that may be applied to the instrument utilizations and corresponding user records. This application of details of the applicable objects to the corresponding user records may be performed in real-time or near real-time and simultaneously for any number of user records associated with the different authorization request messages as these different authorization request messages are received. Thus, in some instances, the system 330 may be configured with various special-purpose components that can facilitate real-time or near real-time processing of different authorization request messages as these messages are received from any number of different merchant systems implemented in different geographic locations and through different communications networks. Further, these various special-purpose components may be configured to automatically apply myriad instrument utilization values for different instrument utilizations (in real-time or near real-time and as the authorization request messages are received) against any applicable authorization and object term variables and/or through the aforementioned machine learning algorithm or artificial intelligence maintained by the system 330, as described above.

If the authorization system 330 implements a machine learning algorithm or artificial intelligence to identify and select objects for different instrument utilizations associated with different merchant systems (including merchant system 308), the authorization system 330 may further retrain or otherwise update the machine learning algorithm or artificial intelligence in real-time or near real-time as feedback corresponding to these objects is received. For example, if the authorization system 330 determines that an object identified by the machine learning algorithm or artificial intelligence is actually not applicable for the present instrument utilization, the authorization system 330 may update the training dataset to indicate that, for this particular instrument utilization, the incorrect decision was produced (e.g., an ineligible object). Further, the training dataset may be updated with an annotation for this particular instrument utilization that provides an indication of the actual decision that should have been obtained (e.g., the correct object eligibility decision, the correct object for the instrument utilization, etc.). This updated training dataset may be processed and used to dynamically update one or more coefficients from the set of coefficients {α1, α2, α3, . . . αn} of the machine learning algorithm or artificial intelligence. The updated machine learning algorithm or artificial intelligence may be re-evaluated and iteratively re-trained according to one or more criteria, as described above, to obtain an updated machine learning algorithm or artificial intelligence that satisfies these one or more criteria. This process of re-training the machine learning algorithm or artificial intelligence may be performed in real-time or near real-time as objects are identified based on received authorization request messages and as feedback corresponding to the identified objects is received. This continuous and dynamic updating process may serve to reduce the potential for erroneous classification of instrument utilizations for object identification and application.

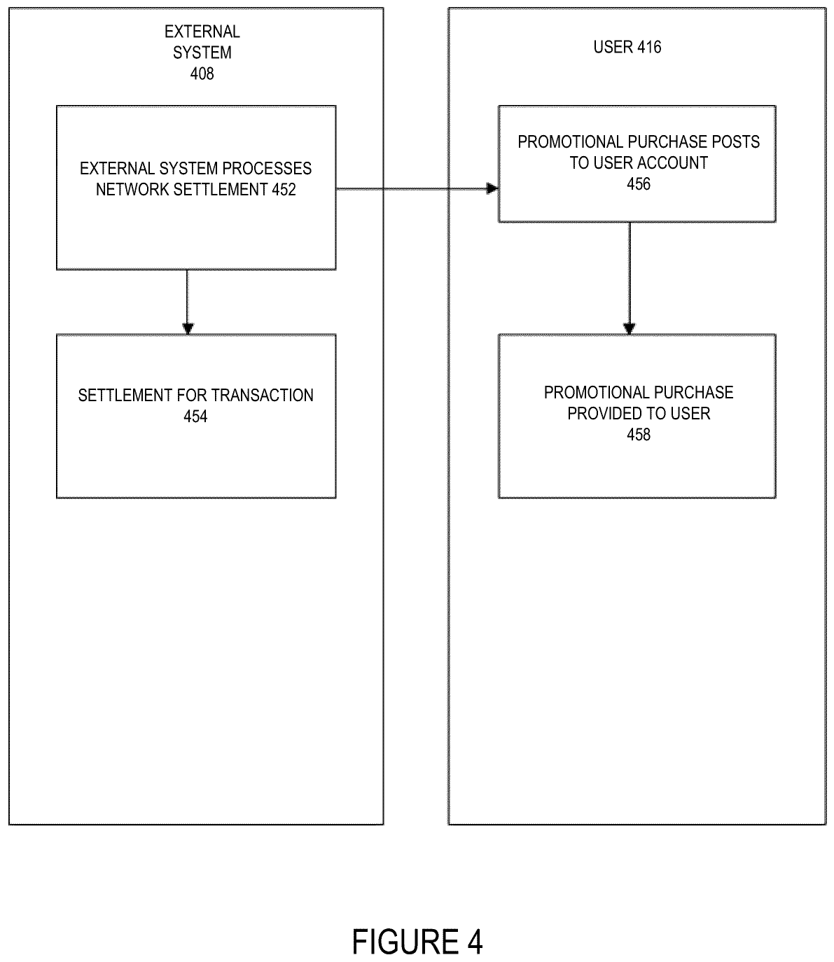

In an embodiment, the post instrument utilization notification is managed through a settlement network as illustrated by FIG. 4. FIG. 4 depicts a system diagram for settlement and statement operations associated with an instrument utilization performed in accordance with the examples illustrated in FIGS. 2 and 3 according to some embodiments. Settlement according to this embodiment may involve at least two entities: external system 408 and user 416. In some implementations, additional entities can be involved in the settlement process.

At step 452, the external system 408 can process a network settlement. At step 454, settlement may occur for the instrument utilization minus any interchange penalties as associated with a record of the user 416 that initiated an instrument utilization (e.g., in step 352). In some embodiments, settlement may occur within 24-48 hours. In other implementations, various different limitations or procedures can be implemented for the settlement. In the examples described herein, notification to the user of the object is not provided as part of the authorization process, but is provided as part of terms associated with a record, indicating the circumstances in which the object can be applied, and is then later communicated to the user during or following settlement. In step 456 the object distribution may post to the user 416 record with one or more specific object terms. This notice of the object terms as applied to a particular instrument utilization can be communicated to a user device, or via any mechanism selected by user 416 and available from a system associated with the authorization system that initiated application of the object. At step 458, the object distribution may appear to the user 416 in a user interface of a user device or via any communication channel associated with a user 416 record.

Thus, as described above, examples implement object distributions with improved device and network performance due to limiting external system involvement with the object and providing functionality for external systems not configured for external system specific objects or network-based objects. In some such implementations, a single authorization system can process different authorization requests from a single user device via two different routes, with in-network routes and external systems processed with external system involvement in objects (e.g. authorization request messages including object data) and out-of-network external systems and paths not involved in objects (e.g. authorization request messages not including object data) as described above in FIGS. 2-4.

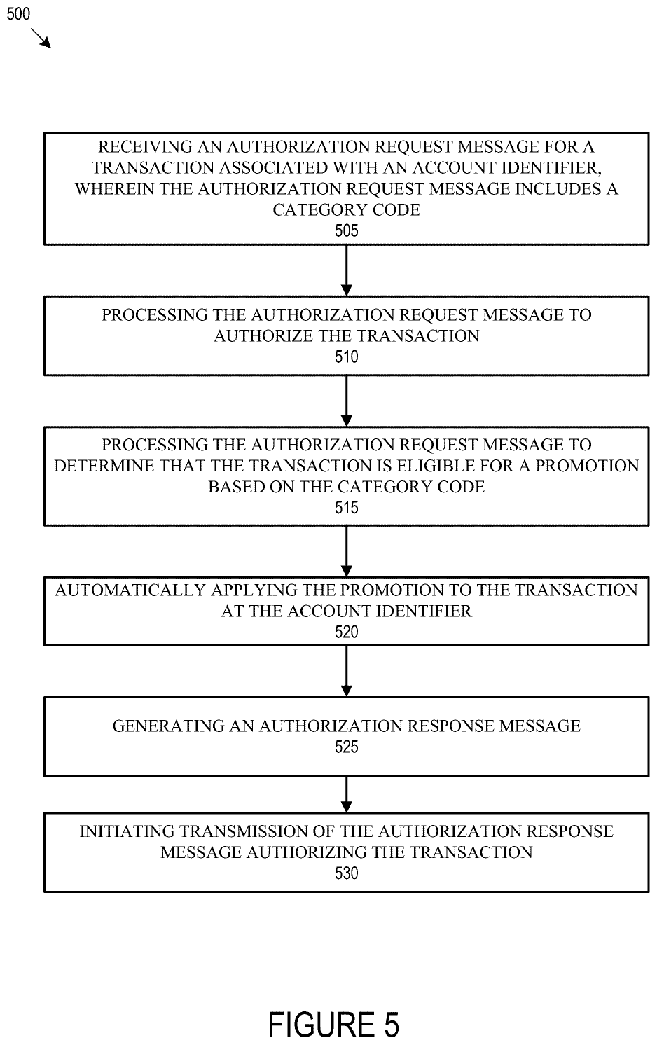

FIG. 5 is a flow diagram illustrating an example method 500 in accordance with some embodiments. Method 500 can be performed by one or more processors of a server computer or server system as part of an authorization system (e.g. authorization systems 130, 230, 330, etc.). Method 500 can, in some examples, be implemented as computer readable instructions that, when executed by processing circuitry of a device, cause the device to perform steps of method 500. In some instances, the example method 500 may be performed through one or more special-purpose components of an authorization system, whereby these one or more special-purpose components may perform the example method 500 in real-time or near-real time for different authorization request messages from different merchant systems as these different authorization request messages are received. Thus, the one or more special-purpose components of the authorization system may dynamically perform the example method 500 simultaneously for any number of authorization request messages that are received concurrently from myriad in-network and out-of-network merchant systems and corresponding to any number of distinct instrument utilizations. This continuous and real-time or near-time processing by the authorization system may provide improved performance of the instrument utilization network through which object eligibility evaluations and object applications are performed, regardless of whether corresponding external systems are in-network or out-of-network.

Method 500 includes step 505 to receive an authorization request message for an instrument utilization associated with a record identifier, wherein the authorization request message includes one or more external system category codes. In some examples, the authorization request message is received via a restricted authorization network that operates independently of the authorization system, with the authorization system configured to apply objects to an instrument utilization and with operations that allow the object to be applied without interaction of the external system or restricted authorization network with object data (e.g., as these systems may not be configured to process such object data). In other examples, any other such systems can be used to provide the authorization request message as part of a object distribution configured with an object to follow a user without certain external systems interacting with the object data. Other examples can include systems where certain external systems interact with certain object data, and other external systems operate without interacting with object data to allow objects (e.g., using different object data) to be applied to instrument utilizations with the other external systems. The authorization request message includes one or more external system category codes, and can include additional instrument utilization data such as an instrument utilization amount, an external system identifier, a network identifier, a record identifier associated with the user and the instrument utilization, or other such information.

Step 510 then processes the authorization request message to authorize the instrument utilization. Step 510 can include various processes in different implementations, including validation systems for confirming the record associated with the user, the external system identity, and/or the item or service involved with the instrument utilization. In one implementation, instrument utilization authorization involves processing an external system identifier and the record identifier from the authorization request message, analyzing one or more instrument utilization values associated with the authorization request message according to a set of applicable fraud rules, and authorizing the instrument utilization based on the set of applicable fraud rules, the external system identifier, and the record identifier. Such rules can involve history data for a user, or risk data that is either tied to the user record or generalized for risk based on similar instrument utilizations (e.g. location, external system, instrument utilization type, instrument utilization patterns, or other such data).

Step 515 processes the authorization request message to determine that the instrument utilization is eligible for an object based on the one or more external system category codes. In some implementations, this processing can include analyzing an external system identifier to confirm that the external system does not belong to an external system group associated with the record identifier (e.g., the external system is an out-of-network external system, the authorization request message was received through a restricted authorization network, etc.). Objects for out-of-network external systems (e.g. non-group external systems) can then be accessed. In various implementations, instrument utilization eligibility determination can include additional steps to identify one or more instrument utilization values from the authorization request message, where the one or more instrument utilization values follow a user associated with the authorization request and the instrument utilization is further determined as eligible based on the one or more instrument utilization values. For example, instrument utilizations above a certain threshold amount can have an automatic object (e.g., a specific interest rate, an interest deferral period, etc.) applied to the instrument utilization at the record number associated with the user. In some implementations, instrument utilizations for an amount below the threshold can be applied to the record under standard terms (e.g., with no objects), or can have a different object. In additional implementations, any such thresholds or triggers for automatic application of an object to an instrument utilization can be used. Such threshold and triggers can be implemented for instrument utilizations occurring within a particular time period, such as a certain month of the year or a certain amount of time since a triggering event (e.g., opening of the record associated with the record number). Such thresholds and triggers can also include ranges, such that an object is applied to a value above a first threshold and below a second threshold. In some implementations, this can be based on data that is not from the authorization request message. For example, if a certain total instrument utilization amount for multiple instrument utilizations is met, data from previous instrument utilizations can be used to trigger automatic application of the object to a current instrument utilization associated with the authorization request message. Such additional data can be stored in an authorization system, or accessed from a networked system or database.

Some implementations of step 515 involve the use of an object table. One example implementation of operations for such a step involve accessing data for an object table (e.g., data stored in an authorization system as part of a previous operation such as step 265). An associated entry in the object table is identified associated with the instrument utilization amount and the category code (e.g. where the data from the authorization request message matches the one or more external system category codes and amount values identified as associated with a particular object in the object table. The object is then identified from the associated entry in the object table. In some implementations of step 515, the authorization system may process the one or more external system category codes, amount values, and any other instrument utilization values through a machine learning algorithm or artificial intelligence to identify an object that may be applied to the instrument utilization. As noted above, the authorization system may dynamically train a machine learning algorithm or artificial intelligence to automatically associate an eligible object to an instrument utilization based on the instrument utilization data values associated with the instrument utilization and the available objects (including any object limitations). For instance, at step 515, the machine learning algorithm or artificial intelligence may dynamically process, in real-time or near real-time and in response to an authorization request message, any instrument utilization values associated with the instrument utilization (e.g., applicable external system category codes, instrument utilization amounts, etc.) for which authorization is being sought, as well as any available user record information and objects, to determine whether the present instrument utilization is eligible for an object and, if so, the particular object that may be applied to the instrument utilization.

In some implementations, a record identifier will have an associated flag indicating that the user was provided a notification of any object terms corresponding to different objects more than a threshold time prior to the instrument utilization data. This threshold time can, for example, be 60 days, 30 days, or any other such threshold time period. Such a threshold time allows sufficient time for the system to provide notice of these object terms outside of the authorization network communication channel. If the flag does not indicate that the user has received sufficient notice for the different objects, the instrument utilization is determined to not be eligible for the object, and standard terms are applied to the instrument utilization. In various implementations, this check against a threshold time can be performed with other checks from an object table or through the machine learning algorithm or artificial intelligence, including external system category code checks to confirm that the instrument utilization is associated with a category that is eligible for the object, that the external system is eligible for the object (e.g. a non-network external system or any other external system category identified by object data) or any other such object eligibility checks.

Step 520 automatically applies the identified object to the instrument utilization at the record identifier associated with the user, which can include using the object data identified from an object table or obtained as output from the machine learning algorithm or artificial intelligence in the authorization system, and generating instrument utilization data by applying the object to the instrument utilization with the record identifier. The instrument utilization data with the object applied can then be communicated to additional systems or subsystems which are used to later communicate with the user involved in the instrument utilization about payments based on the terms of the object (e.g., as part of steps 456, 458, or other such steps).

Step 525 then generates an authorization response message. The authorization response message of method 500 authorizes the instrument utilization, as a rejection of the instrument utilization would not involve step 520, since the object would be moot if the authorization request is rejected.

Step 530 initiates transmission of the authorization response message authorizing the instrument utilization. Subsequent steps to settle the instrument utilization are performed by other systems, such as external system processing the authorization response message and managing network settlement (e.g. in steps 452 and 454) or as part of other channels for communicating with a user and user record outside of the authorization network (e.g. steps 456 and 458).

Method 500 as described above thus improves the operation of devices and networks used with object distributions by allowing instrument utilizations to follow a user instead of an external system, and allowing instrument utilizations to be applied automatically at authorization without the involvement of external systems. Additionally, such objects can be applied for instrument utilizations using restricted authorization networks. Such systems can be used to apply objects when external systems and restriction authorization networks are not configured to accept or manage object data. Further, because the method 500 may be performed simultaneously and in real-time or near real-time for any number of instrument utilizations associated with in-network and out-of-network external systems and as corresponding authorization request messages are received through restricted and unrestricted authorization networks, additional efficiencies are achieved. For instance, as the authorization system identifies objects that may be applied to user records according to in-network and out-of-network instrument utilizations, the authorization system may automatically and in real-time or near real-time apply these objects to these user records as the corresponding authorization request messages are received. Additionally, the authorization system, in real-time or near real-time, may dynamically generate authorization response messages for these received instrument utilizations according to whether the corresponding authentication request message was received through a restricted (e.g., out-of-network external systems) or unrestricted (e.g., in-network external systems) authorization network.

Additionally, as described above, an instrument utilization communication network in accordance with various examples can be configured to perform both method 500 and similar methods, as well as alternative object distributions that do involve external systems or network systems. FIG. 6 describes aspects of one implementation of such a system.

In FIG. 6, a user 622 has a record and associated devices (e.g. a smartphone instrument utilization application or a network instrument) which is configured for authorizations managed by authorization system 630. The record for user 622 is associated with a set of network external systems 608. Such associations can be for external systems focused on a particular set of external system types or external system categories, or any other such collection of external systems. Such associations can be any collection of external systems that register to be associated with record types which include the record of user 622, which can involve registration with object setup system 650 that manages objects via an authorization system 630. Additional aspects of relationships and interactions between object setup system 650 and network external systems 608 are described below. Network external systems 608 can manage objects that follow the external systems 608, including specific object codes that are entered by an external system as part of an instrument utilization involving user 622 and an external system 608. Such instrument utilizations with network external systems 608 can use a first network 626 which is configured to handle object data for network external systems 608 and authorization system 630.

Additionally, the record for user 622 can be configured for use with non-network external systems 618. Configuration for such instrument utilizations can use a passthrough restricted authorization network 624. Such a restricted authorization network 624 can handle communications for an instrument utilization that are standardized without object data, as described above for FIGS. 2-5. As described above, the object setup system 650 for objects applied to non-network external system 618 can provide notification of the object terms to user 622 via a statement system 652 that provides data to user 622, which can use communication channels to user devices associated with the record for user 622, or any other such communication channels. These communication channels allow objects where system configurations do not allow for communication of object data through the authorization network (e.g. passthrough authorization network 624) and external systems not configured for object data (e.g. non-network external systems 618).

In contrast, network external systems 608 and network 626 are configured for such object data. Such configurations can be set using object setup system 650 (e.g., using instructions provided by a networked computer of object setup system 650 providing instructions and data to the network external systems 608) or via configurations implemented by operations of the network external systems 608.

Authorization system 630 can interact with object setup system 650 to implement configurations for handling objects via both network external systems 608 and non-network external systems 618. Authorization system 630 performs validation and fraud detection as described above using validation system 632 and fraud system 634. Such systems can be used to authorize instrument utilizations for the record associated with user 622 from network and non-network external systems. The authorization system 630 can thus accept authorization request messages via both network 626 from network external systems 608 and passthrough restricted authorization network 624 from non-network external systems 618. While two networks 624 and 626 are described, any number of different networks can be used by different implementations of an authorization system 630. For payment authorization requests received by authorization system 630 from non-network external systems 618, objects can be handled as described above in method 500, for example, by accessing a table in object system 636 for non-network objects 638 or applying instrument utilization values from the authorization request message through the aforementioned machine learning algorithm or artificial intelligence and automatically applying the identified object to the instrument utilization at a record identifier associated with user 622 as described above (e.g. in method 500). Objects for network external systems 608 can be handled using different operations and separate object data within object system 636 from network objects 637.

In an embodiment, the authorization system 630 can perform validation and fraud detection for any instrument utilizations originating from network external systems 608 and/or non-network external systems 618 in real-time or near real-time as these instrument utilizations are received. For instance, as different users engage the network external systems 608 and non-network external systems 618, the corresponding communications associated with the instrument utilizations initiated at these systems may be processed by the authorization system 630 as these communications are received through the network 626 and/or the passthrough restricted authorization network 624. Thus, while FIG. 6 provides an illustrative example of communications associated with a particular user record associated with user 622, the authorization system 630 may dynamically process any number of communications received through the network 626 and the passthrough restricted authorization network 624 and corresponding to instrument utilizations associated with different user records and users. This functionality allows the authorization system 630 to dynamically process any number of instrument utilizations concurrently and as these instrument utilizations are received through the network 626 and the passthrough restricted authorization network 624.

In addition to performing validation and fraud detection for any instrument utilizations originating from network external systems 608 and/or non-network external systems 618 in real-time or near real-time as these instrument utilizations are received, the authorization system 630, through the object system 636, can dynamically and in real-time or near real-time, perform various object-related operations according to whether the instrument utilizations were received through the network 626 (e.g., network external systems 608) or the passthrough restricted authorization network 624 (e.g., non-network external systems 618). For instance, the object system 636 may automatically evaluate and parse any received instrument utilizations according to whether the instrument utilizations originated with a network external system 608 or non-network external system 618. The objects that may be applicable to a corresponding user record may be automatically handled by the object system 636 based on this evaluation and through either network objects 637 or non-network objects 638. Once the object system 636 has identified which object may be applied to the user record, the authorization system 630, through the object setup system 650, can either communicate the object to the network external system 608 (e.g., for instrument utilizations received through the network 626) or directly to the user 622 through the statement system 652 (e.g., for instrument utilizations received through the passthrough restricted authorization network 624) according to the origin of the corresponding instrument utilization. This functionality allows the authorization system 630 to dynamically and in real-time or near real-time identify any applicable objects and communicate these objects to network external systems 608 and users 622 according to the instrument utilization sources and as these instrument utilizations are received through the network 626 and the passthrough restricted authorization network 624.

The use of both network 626 and passthrough restricted authorization network 624 for instrument utilizations on a single record associated with user 622 and authorization system 630 allows for a variety of different objects using authorization system 630, including different object data for different networks. This use of different networks can be considered as different rails for instrument utilization communications. In some implementations, network 626 is a network providing rails associated with the authorization system 630, while passthrough restricted authorization network 624 is a third-party network providing rails for a broader set of external systems not connected to network 626. In some systems, restricted authorization networks function as a sub-network on open network rails and directs data of external systems associated with an open network that the sub-network utilizes. This allows open networks to operate with records having specific program limitations. The restricted authorization network can also allow a smaller network to allow records associated with the smaller network (e.g., network 626) to access additional networks without the smaller network having to duplicate infrastructure available in larger open networks. Embodiments described herein enable smaller systems to implement external system specific objects for the networks and external systems directly configured under the control of the smaller system, while allowing different object systems implemented in a larger open network, but with the objects operating independently of the external systems and networks involved with the larger open network.

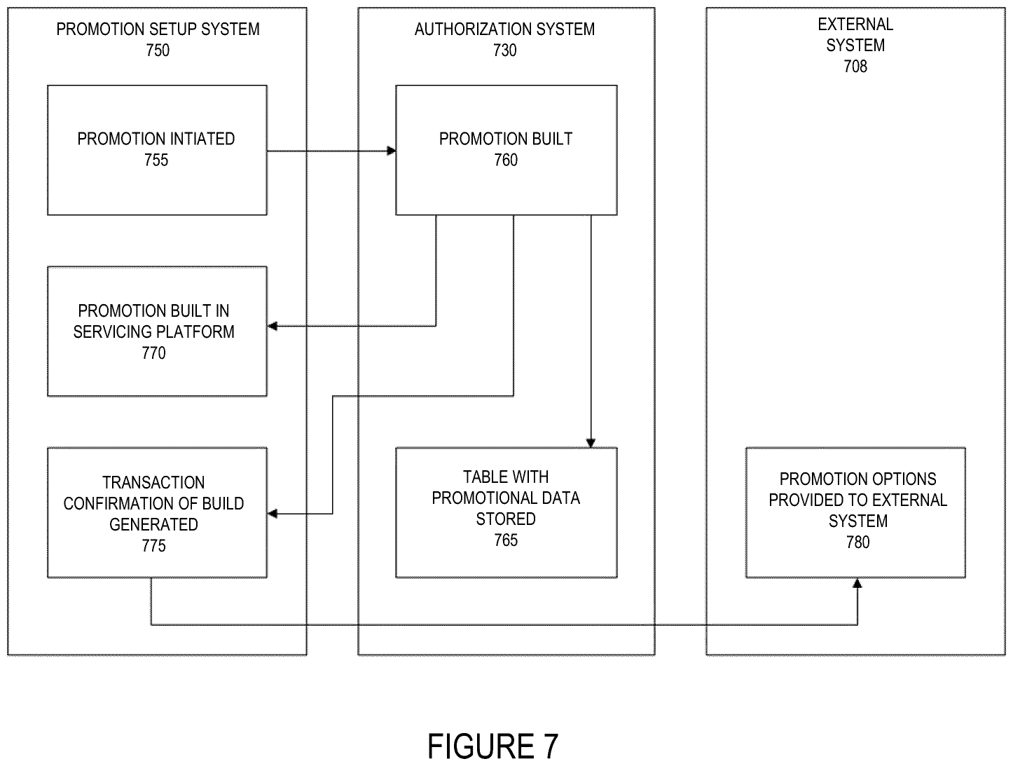

FIG. 7 depicts a system diagram for a first build according to some embodiments. Three entities are depicted: an object setup system 750, an authorization system 730, and external system 708. These entities may be involved in network object systems alongside non-network object systems as illustrated in FIG. 6. Although shown and described with respect to three entities, it is contemplated that any number of entities may be involved in performing the described steps of FIG. 7. Further, the described steps of FIG. 7 may be performed concurrently and in real-time or near real-time for any number of external systems 708 and according to different instrument utilizations associated with these external systems 708 and any non-network external systems as the instrument utilizations are received and processed by the system 730, as described above.

At step 755, objects are initiated by instrument utilizations at the application(s) level as part of the object setup system 750. If additional information is needed, the instrument utilization may be transferred to one or more other systems to obtain the requisite information. At step 760, the objects are built onto the authorization system 730 (e.g. as part of a mainframe system for the in-network configuration and implementation). Once built, the objects are housed in tables at step 765 and stored at the computing devices of authorization system 730 (e.g. a mainframe or networked devices of an authorization system or other similar system as described herein). At step 770, the available objects are further built into a servicing platform. At step 775, an instrument utilization confirmation of the object build is generated. At step 780, a menu of allowable objects and additional information for each object is provided to the external system 708. Thus, in contrast to the objects of FIGS. 2-5 where the object follows the user, the object of FIG. 7 lives with the external system 708, and not the user.

In an embodiment, the authorization system 730 implements and dynamically trains a machine learning algorithm or artificial intelligence to build the objects and provide the menu of allowable objects and additional information for each of these objects. To dynamically train the machine learning algorithm or artificial intelligence to identify and select the allowable objects that may be provided to the external system 708, the authorization system 730 may generate a training dataset. The training dataset may include a set of sample instrument utilizations (e.g., historical instrument utilizations processed by the authorization system 730 or other systems, hypothetical instrument utilizations, etc.), sample record data associated with the sample instrument utilizations, and sample objects resulting from the sample instrument utilizations and corresponding record data. The machine learning algorithm or artificial intelligence may be further subject to one or more criteria that may be used to evaluate the output of the machine learning algorithm or artificial intelligence according to the dataset (e.g., output objects selected from a set of available objects based on the sample inputs in the training dataset). For instance, the set of criteria may include a threshold for the accuracy of the desired machine learning algorithm or artificial intelligence for selecting one or more allowable objects for an authorized instrument utilization.

The authorization system 730 may generate an initial iteration of the machine learning algorithm or artificial intelligence. For instance, the authorization system 730 may initialize a set of coefficients {α1, α2, α3, . . . αn} randomly according to a Gaussian distribution with low variance centered around zero. Using this initial iteration of the machine learning algorithm or artificial intelligence, the authorization system 730 may process a training dataset to generate an output. This output may specify, for each sample instrument utilization included in the dataset, an indication of whether the instrument utilization is eligible for one or more objects that may be provided to the external system 708. The authorization system 730 may compare the output generated using the initial iteration of the machine learning algorithm or artificial intelligence to the sample objects defined in the dataset for each of the data points (e.g., sample instrument utilizations) to identify any inaccuracies or other errors.

If the output of the machine learning algorithm or artificial intelligence does not satisfy the one or more criteria, the authorization system 730 may iteratively update one or more coefficients of the set of coefficients to generate an updated machine learning algorithm or artificial intelligence. This updated machine learning algorithm or artificial intelligence may be used to process the aforementioned training dataset, as well as any additional data points or datasets obtained by the authorization system 730 or from another entity (e.g., a network instrument provider, the external system 708, etc.), to generate a new output. In some instances, the authorization system 730 may use an optimization algorithm to iteratively update one or more coefficients of the set of coefficients. For instance, the authorization system 730 may use gradient descent to update the logistic coefficients of the machine learning algorithm or artificial intelligence to enable generation of new cutoff values that may be used to classify the data points of the previously evaluated dataset and of any new data points obtained by the authorization system 730. The authorization system 730 may use this updated machine learning algorithm or artificial intelligence to process the available data points (e.g., the updated training dataset) and generate a new output. The authorization system 730 may evaluate this new output to determine whether the output satisfies the one or more criteria. This process of updating the set of coefficients associated with the machine learning algorithm or artificial intelligence according to the one or more criteria may be performed iteratively until an updated machine learning algorithm or artificial intelligence is produced that satisfies the one or more criteria.

In an embodiment, if the output generated by the machine learning algorithm or artificial intelligence satisfies the one or more criteria, the authorization system 730 implements the machine learning algorithm or artificial intelligence to dynamically, and in real-time, process any instrument utilizations from different in-network external systems (such as external system 708) to determine whether these instrument utilizations are eligible for objects that may be built and provided to these external systems for current instrument utilizations. In an embodiment, the authorization system 730 uses new instrument utilization data corresponding to newly processed instrument utilizations and any applicable objects applied to these instrument utilizations (if any) to further retrain or otherwise update the machine learning algorithm or artificial intelligence. For instance, as the machine learning algorithm or artificial intelligence produces, in real-time or near real-time, outputs corresponding to different objects that may be applied to different instrument utilizations being processed in real-time or near real-time by the authorization system 730, the authorization system 730 or other evaluator of the machine learning algorithm or artificial intelligence (e.g., a network instrument provider, a third-party auditing service, etc.) may evaluate the output to determine whether the corresponding instrument utilizations are eligible for the identified objects. This evaluation may result in additional annotated data points that may be used to retrain or otherwise update the machine learning algorithm or artificial intelligence in real-time or near real-time. For instance, if the machine learning algorithm or artificial intelligence produces an object for which a corresponding instrument utilization is not eligible for, the corresponding instrument utilization may be annotated to indicate that the machine learning algorithm or artificial intelligence has erroneously selected the object for the particular instrument utilization. Additionally, in some instances, the corresponding instrument utilization may be annotated with the correct determination (e.g., a determination that the instrument utilization is not eligible for an object, etc.). These annotated data points may be added to the training dataset, which may be used to dynamically retrain or otherwise update the machine learning algorithm or artificial intelligence using the process described above.

In some instances, the authorization system 730 may further receive feedback from the external system 708 and other in-network external systems to which the set of allowable objects for eligible instrument utilizations is provided. For instance, as object options are provided to the external system 708 and other in-network external systems for ongoing instrument utilizations, the external system 708 and the other in-network external systems may provide, to the authorization system 730, feedback corresponding to object selections made by corresponding users during their instrument utilizations. These user selections may be used to annotate the data points corresponding to the instrument utilizations associated with these users to indicate which objects were preferred by these users. Accordingly, the authorization system 730 may use the updated training dataset to retrain or otherwise update the machine learning algorithm or artificial intelligence to better select a set of allowable objects that may be built into the servicing platform and provided to the external system 708 and other in-network external systems for presentation to users during their respective instrument utilizations. For instance, the authorization system may dynamically process the updated training dataset (including the provided user feedback with regard to presented objects) to determine whether the machine learning algorithm or artificial intelligence satisfies the aforementioned one or more criteria.

If the machine learning algorithm or artificial intelligence no longer satisfies the one or more criteria based on the updated training dataset, the authorization system 730 may dynamically update one or more coefficients of the set of coefficients for the machine learning algorithm or artificial intelligence. The one or more coefficients may be dynamically updated according to any of the processes described above. The updated machine learning algorithm or artificial intelligence may process the updated training set to generate a new output (e.g., menus of allowable objects) that may be evaluated to again determine whether the machine learning algorithm or artificial intelligence satisfies the one or more criteria. This process may be iteratively performed until an updated machine learning algorithm or artificial intelligence is identified that satisfies the one or more criteria. As new feedback is received from the external system 708 and other in-network external systems with regard to objects selected by different users, the machine learning algorithm and artificial intelligence may be continuously evaluated in real-time or near real-time to ensure that the machine learning algorithm and artificial intelligence continues to satisfy the one or more criteria. For instance, as new feedback is received, the authorization system 730 may dynamically update, in real-time or near real-time, the training dataset used to train the machine learning algorithm or artificial intelligence. This updated training dataset may be used as input to the machine learning algorithm or artificial intelligence for evaluation of the machine learning algorithm or artificial intelligence subject to the one or more criteria, as described above. Any identified failures may cause the authorization system 730 to dynamically, in real-time or near real-time, retrain or otherwise update the machine learning algorithm or artificial intelligence to ensure that the menus of objects that are provided to the external system 708 and other external systems for new instrument utilizations may be applicable to these instrument utilizations and are appealing to the corresponding users.

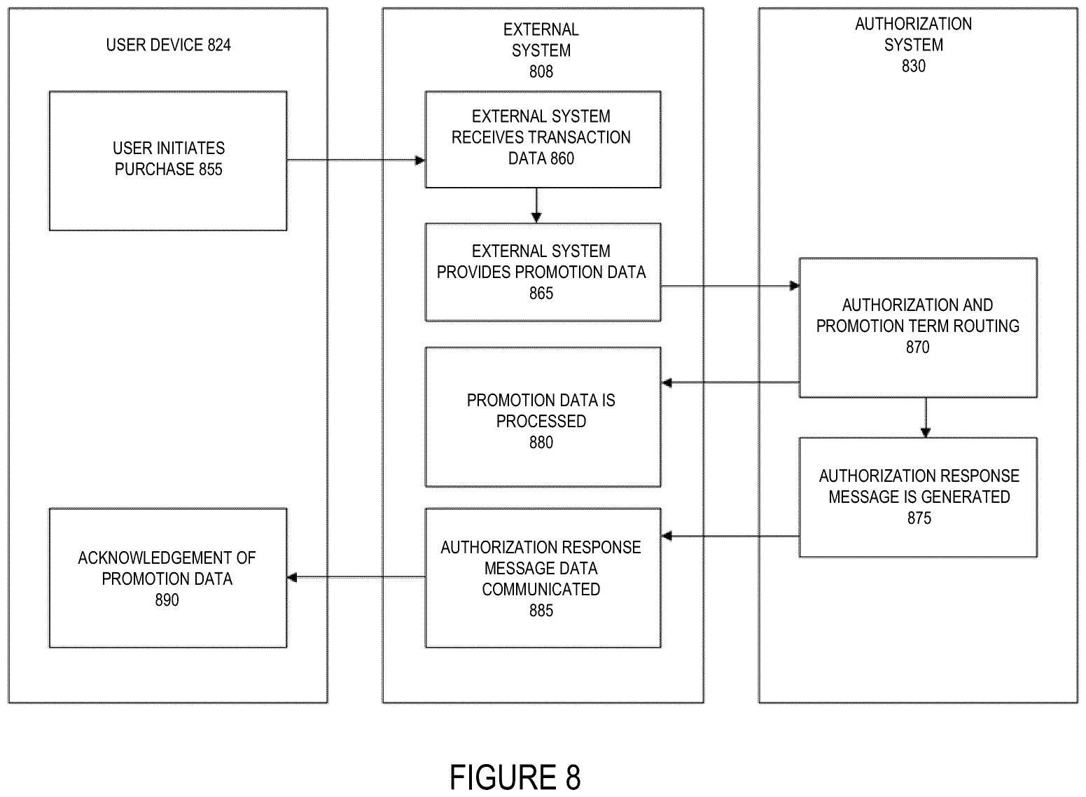

FIG. 8 depicts a system diagram for a first instrument utilization according to some embodiments. Three entities are depicted: user device 824, external system 808, and authorization system 830. These entities may be involved in executing an instrument utilization object process according to some embodiments. Although shown and described with respect to three entities, it is contemplated that any number of entities may be involved in performing the described steps. Although shown and described with different reference numerals, it is contemplated that the entities described herein with the same names may be the same entities. Further, the described steps of FIG. 8 may be performed simultaneously and in real-time or near real-time for any number of external systems 808 and according to different instrument utilizations associated with these external systems 808 and any in-network external systems as the instrument utilizations are received by the authorization system 830, as described above.

At step 855, the user may initiate an instrument utilization using a user device 824 (e.g. a network instrument, smartphone, or other such device associated with the user's record identifier). In some embodiments, the instrument utilization may be made at a location or external system device associated with a particular network instrument service and external system 808. At step 860 the external system receives instrument utilization data (e.g., via a swipe or entry of the user record identifier into an external system device, etc.). At step 865, the external system 808 can input a specific object code for the instrument utilization (e.g., from object options received in step 780). In some embodiments, multiple objects may be available. A user of the merchant system 808 can select which object they want to apply from the allowable objects in the program, or can offer a selection of objects to the user from objects available and selected as options by the external system 808.

At step 870, the instrument utilization may route to the authorization system 830 (e.g., a mainframe) for authorization and object term variables. At step 875, the instrument utilization may be authorized by the authorization system 830. At step 885 receipt data or authorization response message data for the user or instrument utilization can be communicated (e.g., provided for display on user device 824 or printed using an external system device). The communicated response data may include advanced object disclosure language and authorization information which is received and processed in step 880. Communication of such disclosure language can be part of the in-network configuration for an in network merchant and a network managed and configured for special objects as described herein. At step 890, the user can acknowledge communication of the response message data (e.g. by selecting an input on the user device 824 or signing a receipt) acknowledging the object terms in the object data.

In an embodiment, a user's acknowledgement of object terms in the object data can be used to dynamically update, in real-time or near real-time, the aforementioned machine learning algorithm or artificial intelligence trained to provide the external system 808 with a menu of allowable objects for different instrument utilizations that may be initiated through the external system 808. For instance, if the user, through the user device 824, opts to accept the object terms associated with a presented object, the external system 808 may record the user's acceptance of the object as positive feedback with regard to the menu of allowable objects provided to the external system 808 and generated through the machine learning algorithm or artificial intelligence. Alternatively, if the user, through the user device 824, opts to reject the object terms associated with a presented object, the external system 808 may record the user's rejection of the object as negative feedback with regard to the menu of allowable objects. Similarly, if the user accepts the object terms associated with a presented object and it is determined that the present instrument utilization and/or user is actually not eligible for the presented object, this error may be annotated as negative feedback with regard to the menu of allowable objects provided to the external system 808.

The authorization system 830 may obtain feedback with regard to objects presented to users by the external system 808 and any other in-network external system in real-time or near real-time as these users provide their acknowledgement of the presented object data. As this feedback is obtained from the external system 808 and other in-network external systems in real-time or near real-time, the authorization system 830 may dynamically update the training dataset used to train the aforementioned machine learning algorithm or artificial intelligence to incorporate this newly obtained feedback (e.g., adding new data points corresponding to the underlying instrument utilizations, objects presented, and associated user feedback). The authorization system 830 may dynamically process the updated training dataset through the machine learning algorithm or artificial intelligence and evaluate the resulting output according to one or more criteria (e.g., a threshold for the accuracy of the desired machine learning algorithm or artificial intelligence for selecting one or more objects for an authorized instrument utilization and for which the corresponding record is eligible, etc.). If the resulting output does not satisfy the one or more criteria, the authorization system 830 may iteratively update one or more coefficients of the set of coefficients of the machine learning algorithm or artificial intelligence and process the updated training dataset using the iteratively updated machine learning algorithm or artificial intelligence until and output is generated that satisfies the one or more criteria. This iterative retraining or updating of the machine learning algorithm or artificial intelligence may be performed in real-time or near real-time as new feedback is obtained from the external system 808 and any other in-network external systems.

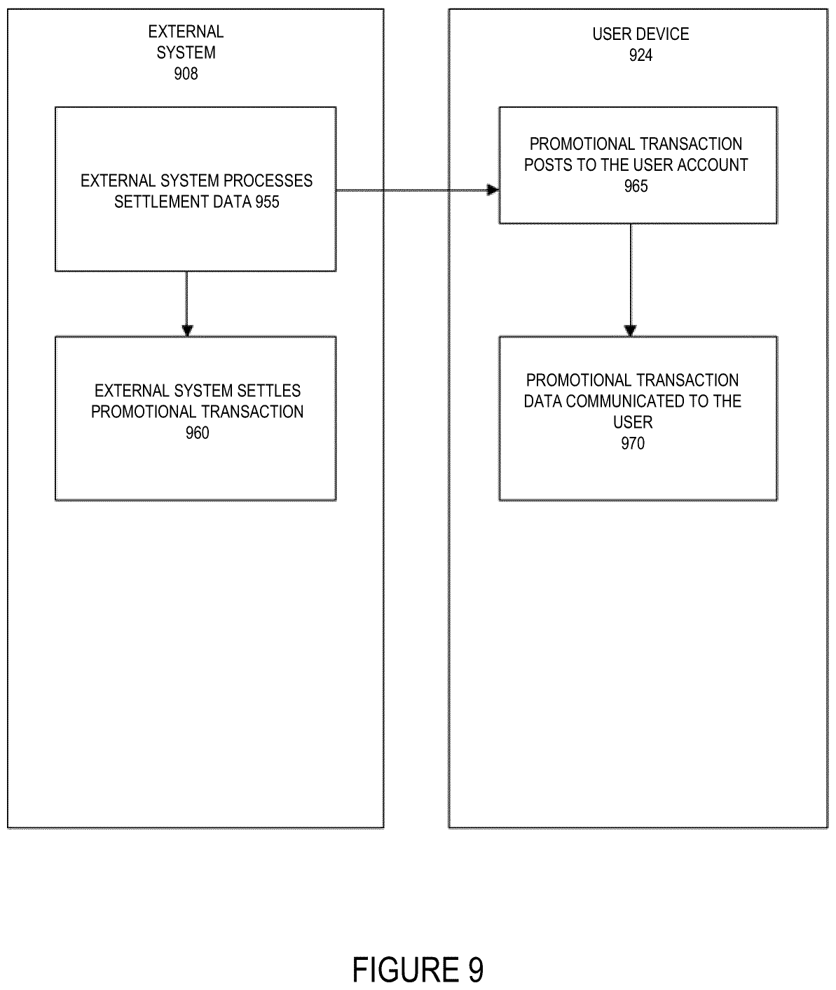

FIG. 9 illustrates a system diagram for a first settlement and statement according to some embodiments. FIG. 9 shows two entities involved in settlement: external system 908 and user device 924. However, any number of additional entities may be involved in the settlement process, such as an issuer system, or other such systems which are not shown.

At step 955, the external system 908 processes the settlement data (e.g. a network instrument settlement associated with the instrument utilization having the applied object as described in FIG. 8). In some implementations, this may occur approximately once per day within external system 908. At step 960, settlement occurs for the instrument utilization minus processing penalties at the external system 908. This may occur within approximately 48 hours of the instrument utilization occurring in some embodiments. At step 965, the object distribution may post to the user record with a specific object term (e.g. using a statement system such as statement system 652). At step 970, the object distribution appears in the user statement.

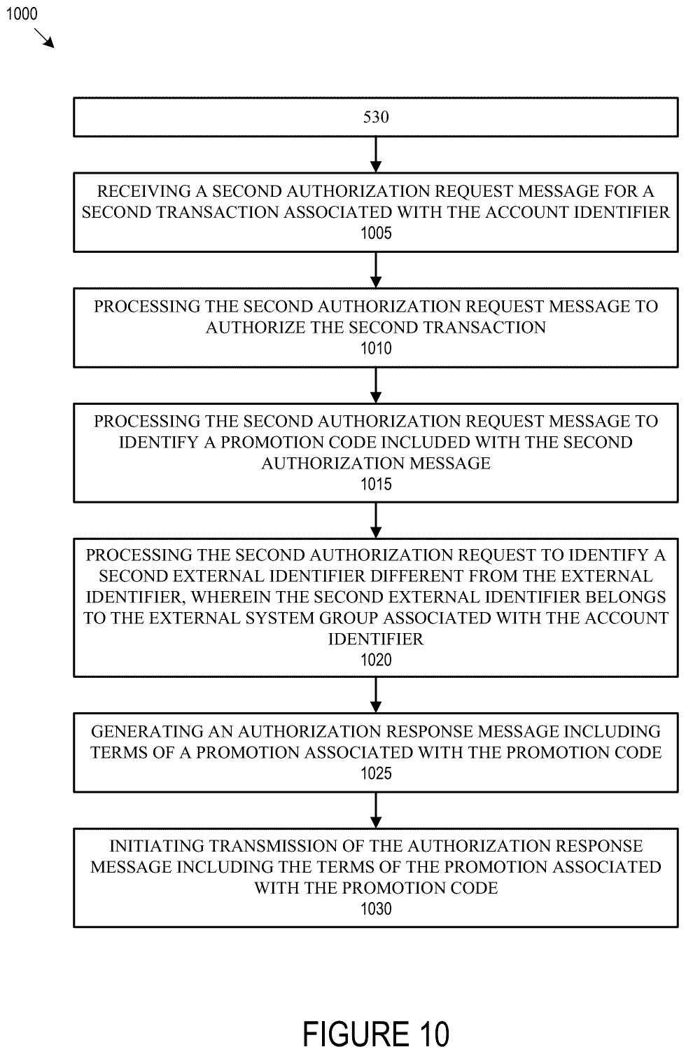

FIG. 10 is a flow diagram illustrating an example method 1000 in accordance with some embodiments. Method 1000 can be performed by one or more processors of a server computer or server system as part of an authorization system (e.g., authorization systems 130, 230, 330, etc.). Method 1000 can, in some examples, be implemented as computer readable instructions that, when executed by processing circuitry of a device, cause the device to perform steps of method 1000. The operations of method 1000 are performed in a system that also performs method 500. The operations of method 1000 can be integrated in various ways with the operations of method 500, and can occur in real-time or near real-time repeatedly in various orders, depending on the external systems utilized by the user associated with a record identifier. Additionally, while methods 500 and 1000 describe operations for a single user and record identifiers, these operations can be performed by an authorization system (e.g. a mainframe system) for any number of users and associated record identifiers concurrently and in real-time or near real-time as authorization request messages are received from different external systems. Additionally object programs for different sets of network affiliations for different groups of external systems, different object programs, or any other such variations, can be implemented within a system as described herein. An authorization system can thus include devices implementing methods 500 and 1000 for different users, different in-network external system groupings, different non-network external system groupings, different communication rails, and other such variations of a system, in accordance with the examples described herein.

Step 1005 of method 1000 includes receipt of a second authorization request message for a second instrument utilization associated with the record identifier. As illustrated, this follows operation of step 530, but as discussed above, such steps can be integrated in a repeated fashion in a system as described herein, including various intervening steps and steps for additional parties. In some instances, the second authorization request message may be received concurrently with the first authorization request message as the associated instrument utilizations corresponding to the record identifier may be processed simultaneously (e.g., received from two different external systems simultaneously, etc.).

Step 1010 includes processing the second authorization request message to authorize the second instrument utilization. Similar to step 510 described above in connection with FIG. 5, step 1010 can include various processes in different implementations, including validation systems for confirming the record associated with the user, the external system identity, and/or the item or service involved with the second instrument utilization. In one implementation, instrument utilization authorization involves processing an external system identifier and the record identifier from the second authorization request message, analyzing one or more instrument utilization values associated with the second authorization request message according to a set of applicable fraud rules, and authorizing the instrument utilization based on the set of applicable fraud rules, the external system identifier, and the record identifier. As noted above, such rules can involve history data for a user, or risk data that is either tied to the user record or generalized for risk based on similar instrument utilizations (e.g. location, external system, instrument utilization type, instrument utilization patterns, or other such data).

Step 1015 processes the second authorization request message to identify an object code included with the second authorization message. As noted above, the second authorization request message may originate from an in-network external system that may be associated with an issuer (e.g., network instrument provider, etc.) of the record identifier. Accordingly, in such instances, the in-network external system may maintain a menu of allowable objects and additional information for each object provided by the authorization system, as described above in connection with FIGS. 7-8. When a user initiates an instrument utilization with the in-network external system, the in-network external system may select an object code for the instrument utilization. This object code may correspond to a particular object from the menu of allowable objects provided by the authorization system.

Step 1020 processes the second authorization request to identify a second external system identifier different from the first external system identifier, where the second external system identifier belongs to the external system group associated with the record identifier. As a result of the second external system identifier being associated with an in-network external system group (e.g., external systems that may participate in the object process, etc.), the authorization system may determine that the external system associated with the second authorization request message may receive and present any applicable object terms to the user associated with the record identifier. If the second authorization request message was received from an out-of-network external system, the authorization system may determine that the applicable object terms cannot be provided to the out-of-network external system. Thus, the resulting authorization response message to the out-of-network external system may be devoid of any object terms.

If the second external identifier corresponds to an in-network external system that is associated with an in-network external system group, the authorization system, at step 1025, generates an authorization response message including terms of an object associated with the object code. For instance, the authorization system may use the provided object code to identify the corresponding object that is to be applied to the instrument utilization. For this object, the authorization system may retrieve any applicable object terms that may be presented to the user through the in-network external system. The authorization system may include, within the authorization response message, the object terms associated with the selected object.

At step 1030, the authorization system initiates transmission of the authorization response message including the terms of the object associated with the received object code. In an embodiment, if the authorization system generated the menu of allowable objects through a machine learning algorithm or artificial intelligence (as described in greater detail herein), the authorization system uses feedback with regard to the selected object to further retrain or otherwise update the machine learning algorithm or artificial intelligence. For instance, a user's acknowledgement of object terms in the provided authorization response message can be used to dynamically update, in real-time or near real-time, the aforementioned machine learning algorithm or artificial intelligence trained to provide the in-network external system with a menu of allowable objects for different instrument utilizations that may be initiated through the in-network external system. Returning to an earlier example, if the user associated with the second instrument utilization opts to accept the object terms associated with a presented object, the external system may record the user's acceptance of the object as positive feedback with regard to the menu of allowable objects provided to the external system and generated through the machine learning algorithm or artificial intelligence. Alternatively, if the user associated with the second instrument utilization opts to reject the object terms associated with a presented object, the external system may record the user's rejection of the object as negative feedback with regard to the menu of allowable objects. Similarly, if the user accepts the object terms associated with a presented object and it is determined that the present instrument utilization and/or user is actually not eligible for the presented object, this error may be annotated as negative feedback with regard to the menu of allowable objects provided to the in-network external system. This feedback may be used to update the training dataset used to evaluate and update the machine learning algorithm or artificial intelligence, as described above.

These steps can then be repeated or performed in real-time or near real-time with the steps of method 500 as the user initiates instrument utilizations with combinations of in-network merchants for method 1000 and out-of-network merchants for method 500. Further, the steps of both method 500 and method 1000 may be performed in real-time or near real-time for different instrument utilizations associated with different users and external systems (e.g., in-network external systems and out-of-network external systems) according to the network through which the corresponding authorization request messages were received (e.g., network 626 or a passthrough restricted authorization network 624, as described above in connection with FIG. 6). The authorization system may thus concurrently and in real-time or near real-time perform the steps of method 500 and method 1000 as these different instrument utilizations as the corresponding authorization request messages are received.

FIG. 11 illustrates a computing system architecture 1100 including various components in electrical communication with each other using a connection 1106, such as a bus, in accordance with some implementations. Example system architecture 1100 includes a processing unit (CPU or processor) 1104 and a system connection 1106 that couples various system components including the system memory 1120, such as ROM 1118 and RAM 1116, to the processor 1104. The system architecture 1100 can include a cache 1102 of high-speed memory connected directly with, in close proximity to, or integrated as part of the processor 1104. The system architecture 1100 can copy data from the memory 1120 and/or the storage device 1108 to the cache 1102 for quick access by the processor 1104. In this way, the cache can provide a performance boost that avoids processor 1104 delays while waiting for data. These and other modules can control or be configured to control the processor 1104 to perform various actions.

Other system memory 1120 may be available for use as well. The memory 1120 can include multiple different types of memory with different performance characteristics. The processor 1104 can include any general purpose processor and a hardware or software service, such as service 1 1110, service 2 1112, and service 3 1114 stored in storage device 1108, configured to control the processor 1104 as well as a special-purpose processor where software instructions are incorporated into the actual processor design. The processor 1104 may be a completely self-contained computing system, containing multiple cores or processors, a bus, memory controller, cache, etc. A multi-core processor may be symmetric or asymmetric.

To enable user interaction with the computing system architecture 1100, an input device 1122 can represent any number of input mechanisms, such as a microphone for speech, a touch-sensitive screen for gesture or graphical input, keyboard, mouse, motion input, speech and so forth. An output device 1124 can also be one or more of a number of output mechanisms known to those of skill in the art. In some instances, multimodal systems can enable a user to provide multiple types of input to communicate with the computing system architecture 1100. The communications interface 1126 can generally govern and manage the user input and system output. There is no restriction on operating on any particular hardware arrangement and therefore the basic features here may easily be substituted for improved hardware or firmware arrangements as they are developed.

Storage device 1108 is a non-volatile memory and can be a hard disk or other types of computer readable media which can store data that are accessible by a computer, such as magnetic cassettes, flash memory cards, solid state memory devices, digital versatile disks, cartridges, RAMs 1116, ROM 1118, and hybrids thereof.

The storage device 1108 can include services 1110, 1112, 1114 for controlling the processor 1104. Other hardware or software modules are contemplated. The storage device 1108 can be connected to the system connection 1106. In one aspect, a hardware module that performs a particular function can include the software component stored in a computer-readable medium in connection with the necessary hardware components, such as the processor 1104, connection 1106, output device 1124, and so forth, to carry out the function.

The disclosed gift selection, attribution, and distribution system can be performed using a computing system. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device. The processor may be configured to carry out all or part of methods described herein for example by executing code for example stored in memory. One or more of a user device or computer, a provider server or system, or a suspended database update system may include the components of the computing system or variations on such a system.

This disclosure contemplates the computer system taking any suitable physical form, including, but not limited to a Point-of-Sale system (“POS”). As example and not by way of limitation, the computer system may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud, which may include one or more cloud components in one or more networks. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor may be, for example, be a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory can be coupled to the processor by, for example, a bus. The memory can include, by way of example but not limitation, random access memory (RAM), such as dynamic RAM (DRAM) and static RAM (SRAM). The memory can be local, remote, or distributed.

The bus can also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software can be stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The bus can also couples the processor to the network interface device. The interface can include one or more of a modem or network interface. It will be appreciated that a modem or network interface can be considered to be part of the computer system. The interface can include an analog modem, Integrated Services Digital network (ISDN0 modem, cable modem, token ring interface, satellite transmission interface (e.g., “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device.

In operation, the computer system can be controlled by operating system software that includes a file management system, such as a disk operating system. One example of operating system software with associated file management system software is the family of operating systems known as Windows® from Microsoft Corporation of Redmond, WA, and their associated file management systems. Another example of operating system software with its associated file management system software is the Linux™ operating system and its associated file management system. The file management system can be stored in the non-volatile memory and/or drive unit and can cause the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any system capable of executing a set of instructions (sequential or otherwise) that specify actions to be taken by that system.

While the machine-readable medium or machine-readable storage medium is shown, by way of example, to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the subject matter to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description.

As used herein, the terms “connected,”“coupled,” or any variant thereof when applying to modules of a system, means any connection or coupling, either direct or indirect, between two or more elements; the coupling of connection between the elements can be physical, logical, or any combination thereof. Additionally, the words “herein,”“above,”“below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

It is also noted that individual implementations may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included (e.g. in FIG. 5 or 10). A process may correspond to a method, a function, a procedure, a subroutine, a subprogram, etc. When a process corresponds to a function, its termination can correspond to a return of the function to the calling function or the main function.

Client devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things. The input devices can include, for example, a keyboard, a mouse, a key pad, a touch interface, a microphone, a camera, and/or other types of input devices. The output devices can include, for example, a display screen, a speaker, a haptic feedback system, a printer, and/or other types of output devices. A data storage device, such as a hard drive or flash memory, can enable the computing device to temporarily or permanently store data. A network interface, such as a wireless or wired interface, can enable the computing device to communicate with a network. Examples of computing devices include desktop computers, laptop computers, server computers, hand-held computers, tablets, smart phones, personal digital assistants, digital home assistants, as well as machines and apparatuses in which a computing device has been incorporated.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

The various examples discussed above may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments). A processor(s), implemented in an integrated circuit, may perform the necessary tasks.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method, comprising:
receiving data corresponding to a set of available objects, wherein the data is associated with a restricted authorization network, and wherein the restricted authorization network does not support inclusion of object terms associated with the set of available objects in authorization request messages;
dynamically training in real-time a machine learning algorithm to identify allowable objects from the set of available objects, wherein the machine learning algorithm is dynamically trained by processing a dataset including sample instrument utilizations and corresponding sample objects through the machine learning algorithm and iteratively updating one or more coefficients of the machine learning algorithm until one or more criteria are satisfied;
processing the data through the machine learning algorithm to obtain a set of allowable objects;
receiving an authorization request message through the restricted authorization network, wherein the authorization request message is associated with an instrument utilization, and wherein the authorization request message does not include any object terms;
generating an authorization response message with no object information;
performing post-processing of the instrument utilization by applying an object from the set of allowable objects, wherein the object is selected based on a set of instrument utilization values associated with the instrument utilization; and
dynamically updating the machine learning algorithm in real-time based on feedback corresponding to the object and a set of other objects associated with other authorization request messages received through the restricted authorization network, wherein the machine learning algorithm is dynamically updated as the feedback is received.

2. The computer-implemented method of claim 1, wherein the machine learning algorithm is dynamically trained by iteratively modifying a set of coefficients associated with the machine learning algorithm until an output is generated that satisfies one or more criteria.

3. The computer-implemented method of claim 1, further comprising:
evaluating the set of instrument utilization values and an external system identifier corresponding to the instrument utilization to determine that the instrument utilization is eligible for the object.

4. The computer-implemented method of claim 1, further comprising:
extracting an external system identifier and a record identifier from the authorization request message;
analyzing the set of instrument utilization values using a set of fraud rules; and
authorizing the instrument utilization based on the set of fraud rules, the external system identifier, and the record identifier.

5. The computer-implemented method of claim 1, further comprising:
extracting an external system identifier and a record identifier from the authorization request message; and
determining that the instrument utilization is eligible for the object as a result of the external system identifier not being associated with an external system group corresponding to the record identifier.

6. The computer-implemented method of claim 1, wherein performing post-processing of the process further comprises:
applying the object to the instrument utilization and other instrument utilizations associated with a same record identifier, wherein the object is applied once a bundled threshold amount is exceeded.

7. The computer-implemented method of claim 1, wherein the feedback indicates whether object terms associated with the object and the set of other objects were accepted by corresponding users.

8. A system, comprising:
one or more processors; and
memory storing thereon instructions that, as a result of being executed by the one or more processors, cause the system to:
receive data corresponding to a set of available objects, wherein the data is associated with a restricted authorization network, and wherein the restricted authorization network does not support inclusion of object terms associated with the set of available objects in authorization request messages;
dynamically train in real-time a machine learning algorithm to identify allowable objects from the set of available objects, wherein the machine learning algorithm is dynamically trained by processing a dataset including sample processes and corresponding sample objects through the machine learning algorithm and iteratively updating one or more coefficients of the machine learning algorithm until one or more criteria are satisfied;
process the data through the machine learning algorithm to obtain a set of allowable objects;
receive an authorization request message through the restricted authorization network, wherein the authorization request message is associated with a process, and wherein the authorization request message does not include any object terms;
generate an authorization response message with no object information;
perform post-processing of the process by applying an object from the set of allowable objects, wherein the object is selected based on a set of process values associated with the process; and
dynamically update the machine learning algorithm in real-time based on feedback corresponding to the object and a set of other objects associated with other authorization request messages received through the restricted authorization network, wherein the machine learning algorithm is dynamically updated as the feedback is received.

9. The system of claim 8, wherein the machine learning algorithm is dynamically trained by iteratively modifying a set of coefficients associated with the machine learning algorithm until an output is generated that satisfies one or more criteria.

10. The system of claim 8, wherein the instructions further cause the system to:
evaluate the set of process values and an external system identifier corresponding to the process to determine that the process is eligible for the object.

11. The system of claim 8, wherein the instructions further cause the system to:
extract an external system identifier and a record identifier from the authorization request message;
analyze the set of process values using a set of fraud rules; and
authorize the process based on the set of fraud rules, the external system identifier, and the record identifier.

12. The system of claim 8, wherein the instructions further cause the system to:
extract an external system identifier and a record identifier from the authorization request message; and
determine that the process is eligible for the object as a result of the external system identifier not being associated with an external system group corresponding to the record identifier.

13. The system of claim 8, wherein the instructions that cause the system to perform post-processing of the process further cause the system to:
apply the object to the process and other processes associated with a same record identifier, wherein the object is applied once a bundled threshold amount is exceeded.

14. The system of claim 8, wherein the feedback indicates whether object terms associated with the object and the set of other objects were accepted by corresponding users.

15. A non-transitory, computer-readable storage medium storing thereon executable instructions that, as a result of being executed by one or more processors of a computer system, cause the computer system to:
receive data corresponding to a set of available objects, wherein the data is associated with a restricted authorization network, and wherein the restricted authorization network does not support inclusion of object terms associated with the set of available objects in authorization request messages;
dynamically train in real-time a machine learning algorithm to identify allowable objects from the set of available objects, wherein the machine learning algorithm is dynamically trained by processing a dataset including sample processes and corresponding sample objects through the machine learning algorithm and iteratively updating one or more coefficients of the machine learning algorithm until one or more criteria are satisfied;
process the data through the machine learning algorithm to obtain a set of allowable objects;
receive an authorization request message through the restricted authorization network, wherein the authorization request message is associated with a process, and wherein the authorization request message does not include any object terms;
generate an authorization response message with no object information;
perform post-processing of the process by applying an object from the set of allowable objects, wherein the object is selected based on a set of process values associated with the process; and
dynamically update the machine learning algorithm in real-time based on feedback corresponding to the object and a set of other objects associated with other authorization request messages received through the restricted authorization network, wherein the machine learning algorithm is dynamically updated as the feedback is received.

16. The non-transitory, computer-readable storage medium of claim 15, wherein the machine learning algorithm is dynamically trained by iteratively modifying a set of coefficients associated with the machine learning algorithm until an output is generated that satisfies one or more criteria.

17. The non-transitory, computer-readable storage medium of claim 15, wherein the executable instructions further cause the computer system to:
evaluate the set of process values and an external system identifier corresponding to the process to determine that the process is eligible for the object.

18. The non-transitory, computer-readable storage medium of claim 15, wherein the executable instructions further cause the computer system to:
extract an external system identifier and a record identifier from the authorization request message;
analyze the set of process values using a set of fraud rules; and
authorize the process based on the set of fraud rules, the external system identifier, and the record identifier.

19. The non-transitory, computer-readable storage medium of claim 15, wherein the executable instructions further cause the computer system to:
extract an external system identifier and a record identifier from the authorization request message; and
determine that the process is eligible for the object as a result of the external system identifier not being associated with an external system group corresponding to the record identifier.

20. The non-transitory, computer-readable storage medium of claim 15, wherein the executable instructions that cause the computer system to perform post-processing of the process further cause the computer system to:
apply the object to the process and other processes associated with a same record identifier, wherein the object is applied once a bundled threshold amount is exceeded.

21. The non-transitory, computer-readable storage medium of claim 15, wherein the feedback indicates whether object terms associated with the object and the set of other objects were accepted by corresponding users.
